(19) United States
(12) Patent Application Publication
(10) Pub. No.: US 2006/0104351 A1
(43) Pub. Date: May 18, 2006

(54) Video/image processing devices and methods

(76) Inventor: Shu-Wen Teng, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/988,936

(22) Filed: Nov. 15, 2004

(51) Int. Cl. H04N 11/04; G06K 9/36; H04N 7/12; G06K 9/46; H04B 1/66

(52) U.S. Cl. 375/240.03; 375/240.12; 375/240.2; 382/232; 375/240.23

(57) ABSTRACT

Video/image processing devices. A memory stores first processed data, second processed data, and discrete cosine transformed data. An MPEG subsystem processes an MPEG codec according to first input data and the discrete cosine transformed data, and generates the first processed data and a first trigger signal in response to receiving a first enable signal. A JPEG subsystem processes JPEG codec according to second input data and the discrete cosine transformed data, and generates the second processed data and a second trigger signal in response to receiving a second enable signal. A discrete cosine transform module transforms the first processed data according to the first trigger signal to the discrete cosine transformed data, and transforms the second processed data according to the second trigger signal to the discrete cosine transformed data. A processor provides the first enable signal and the second enable signal.

### BACKGROUND

The present disclosure relates in general to image processing. In particular, the present disclosure relates to image processing involving Moving Picture Experts Group (MPEG) and Joint Photographic Experts Group (JPEG) coding/decoding (codec).

MPEG is used in many current and emerging products, including digital television set-top boxes, digital satellite system (DSS), high-definition television (HDTV) decoders, digital versatile disk (DVD) players, video conferencing, internet video, and other applications. These applications benefit from video compression as less storage space is required for archiving video. Moreover, less bandwidth is required for video transmission.

MPEG-4 is a video compression standard for transmission and manipulation of video data in multimedia environments. In this regard, FIG. 1 is a schematic diagram of a conventional MPEG system 10. The conventional MPEG system 10 includes an MPEG encoder 102 and an MPEG decoder 104. MPEG encoder 102 includes a motion estimation device 1021, a forward discrete cosine transform (FDCT) module 1023, a quantizer 1025, a scan device 1027, and a variable-length coding (VLC) device 1029. MPEG decoder 104 includes a motion compensation processor 1041, an inverse discrete cosine transform (IDCT) module 1043, an inverse scan device 1045, a dequantizer 1047, and a variable-length decoding (VLD) device 1049.

In encode operation, Motion estimation device 1021 generates estimated video data according to the input video data VIDEO and feedback data. In some embodiments, motion estimation device 1021 determines a compression mode for the video data VIDEO according to the difference between the video data VIDEO and the feedback data. FDCT module 1023 processes the estimated video data by discrete cosine transformation to generate transformed MPEG data. Quantizer 1025 quantizes the transformed MPEG data. Scan device 1027 scans the quantized MPEG data to transform the quantizes MPEG data into a serial string of quantized coefficients. The run-length value, and the value of the non-zero coefficient which the run of zero coefficients precedes, are then combined and coded using VLC device 1029 to generate compressed data. MPEG encoder 102 may comprises a feedback loop between quantizer 1025 and motion estimation device 1021. The feedback path is formed using dequantizer 1047 and IDCT module 1043 of the MPEG decoder 104. The dequantizer 1047 dequantizes the quantized MPEG data generated by quantizer 1025 and generates corresponding dequantized data. The IDCT module 1043 performs inverse discrete cosine transformation by row-column decomposition for the dequantized data to generate the feedback data for estimation.

In decode operation, VLD device 1049 processes the MPEG compressed data by variable-length decoding to generate serial string data. Inverse scan device 1045 transforms the serial string data into scanned video data. Dequantizer 1047 dequantizes the scanned video data to dequantized video data. The IDCT module 1043 processes the dequantized video data into transformed MPEG data by inverse discrete cosine transformation to generate inverse discrete cosine transformed data. Motion compensation device 1041 compensates the discrete cosine transformed data and generates a compensated MPEG data.

In MPEG compression, motion estimation algorithms calculate the motion between successive video frames and predict a current frame from previously transmitted frames using motion data. Global motion estimation (GME) algorithms estimate a single parametric motion model for an entire frame that can be compressed to produce either static or dynamic sprites. Static sprites are mosaics containing visual data of objects that are visible throughout a sequence. While various mosaic generation algorithms have been developed, their applicability to general purpose video compression applications is limited by the typically significant delay incurred by frame accumulation and mosaic image coding (as intra frames). Furthermore, the 8-parameter projective motion model used by the MPEG-4 coding standard is only suitable for a limited range of camera motions. Thus, each static sprite can be only used for a single short video segment.

JPEG is another standardized image compression mechanism. FIG. 2 is a schematic diagram of a conventional JPEG system 20. The conventional JPEG system 20 includes a JPEG encoder 202 and a JPEG decoder 204. JPEG encoder 202 includes a forward discrete cosine transform (FDCT) module 2021, a quantizer 2023, a scan device 2025, and a variable-length coding device 2027. JPEG decoder 204 includes an inverse discrete cosine transform (IDCT) module 2041, an inverse scan device 2043, a dequantizer 2045, and a variable-length decoding device 2047.

In encode operation, FDCT module 2021 processes image data by discrete cosine transformation to generate transformed JPEG data. Quantizer 2023 quantizes the transformed JPEG data. Scan device 2025 scans the transformed JPEG data to transform the transformed JPEG data into a serial string of quantized coefficients. The run-length value, and the value of the non-zero coefficient which the run of zero coefficients precedes, are then combined and coded using VLC device 2027 to generate a compressed data. In decode operation, VLD device 2047 processes the JPEG compressed data by variable-length decoding to generate serial string data. Inverse scan device 2043 transforms the serial string data into scanned image data. Dequantizer 2045 dequantizes the scanned image data to dequantized image data. The IDCT module 2041 processes the dequantized image data into transformed JPEG data by inverse discrete cosine transformation to generate inverse discrete cosine transformed data.

JPEG is designed for compression of full-color or gray-scale images of natural, real-world scenes. JPEG compression is particularly well suited for photographs, naturalistic artwork, and similar material, and is less well suited for lettering, simple cartoons, or line drawings. JPEG compression handles only still images. Small errors introduced by JPEG compression may be problematic for images intended for machine-analysis as JPEGs are designed primarily for human viewing.

MPEG and JPEG compression technology is popularly implemented for display of images on personal mobile electronic devices, such as cell phones and personal digital assistants (PDAs), which comprise independent hardware for respectively implementing MPEG and JPEG compression technology.

### SUMMARY

Video/image processing devices are provided. A video/image processing device for processing input/output video/image data, comprises: an MPEG (Moving Pictures Expert Group) subsystem for processing the input/output video data in a first video processing phase and a second video processing phase; a JPEG (Joint Photographic Experts Group) subsystem for processing the input/output image data in a first image processing phase and a second image processing phase; a DCT (Discrete Cosine Transform) subsystem connected between the MPEG subsystem and the JPEG subsystem for transforming the input/output video/image data; a memory connected to the DCT subsystem, the MPEG subsystem, and the JPEG subsystem; in response to the MPEG/JPEG subsystem completing the first video/image processing phase of the processing of the input/output video/image data, the MPEG/JPEG subsystem stores first-MPEG/JPEG-processed data in the memory, and sends an MPEG/JPEG control signal to the DCT subsystem; in response to the MPEG/JPEG control signal, the DCT subsystem reads the first-MPEG/JPEG-processed data from the memory, transforms the first-MPEG/JPEG-processed data into transformed MPEG/JPEG data, stores the transformed MPEG/JPEG data in the memory, and sends a DCT control signal to the MPEG/JPEG subsystem; in response to the DCT control signal, the MPEG/JPEG subsystem reads the transformed MPEG/JPEG data from the memory, and performs the second video/image processing phase of the processing of the input/output video/image data.

Another embodiment of a video/image encoding device for encoding input video/image data, comprises: an MPEG sub-encoder for encoding the input video data in a first video encoding phase and a second video encoding phase; a JPEG sub-encoder for encoding the input image data in a first image encoding phase and a second image encoding phase; a FDCT (Forward Discrete Cosine Transform) module for transforming the input video/image data; and a memory connected to the MPEG sub-encoder, the JPEG sub-encoder and the FDCT module; in response to the MPEG/JPEG sub-encoder completing the first video/image encoding phase of the encoding of the input video/image data, the MPEG/JPEG sub-encoder stores first-MPEG/JPEG-encoded data in the memory, and sends the MPEG/JPEG control signal to the FDCT module; in response to the MPEG/JPEG control signal, the FDCT module reads the first-MPEG/JPEG-encoded data from the memory, transforms the first-MPEG/JPEG-encoded data into transformed MPEG/JPEG data, stores the transformed MPEG/JPEG data in the memory, and sends the DCT control signal to the MPEG/JPEG sub-encoder; in response to the DCT control signal, the MPEG/JPEG sub-encoder reads the transformed MPEG/JPEG data from the memory, and performs the second video/image encoding phase of the encoding of the input video/image data.

Another embodiment of a video/image decoding device for decoding output video/image data, comprises: an MPEG sub-decoder for decoding the output video data in a first video decoding phase and a second video decoding phase; a JPEG sub-decoder for decoding the output image data in a first image decoding phase and a second image decoding phase; an IDCT(Inverse Discrete Cosine Transform) module for transforming the output video/image data; and a memory connected to the MPEG sub-decoder, the JPEG sub-decoder and the IDCT module; in response to the MPEG/JPEG sub-decoder completing the first video/image decoding phase of the decoding of the output video/image data, the MPEG/JPEG sub-decoder stores first-MPEG/JPEG-decoded data in the memory, and sends the MPEG/JPEG control signal to the IDCT module; in response to the MPEG/JPEG control signal, the IDCT module reads the first-MPEG/JPEG-decoded data from the memory, transforms the first-MPEG/JPEG-decoded data into transformed MPEG/JPEG data, storing the transformed MPEG/JPEG data in the memory, and sends the DCT control signal to the MPEG/JPEG sub-decoder; in response to the DCT control signal, the MPEG/JPEG sub-decoder reads the transformed MPEG/JPEG data from the memory, and performs the second video/image decoding phase of the decoding of the output video/image data.

Another embodiment of an electronic device for processing input/output video/image data, comprises a video/image processing device, comprising: an MPEG (Moving Pictures Expert Group) subsystem for processing the input/output video data in a first video processing phase and a second video processing phase; a JPEG (Joint Photographic Experts Group) subsystem for processing the input/output image data in a first image processing phase and a second image processing phase; a DCT (Discrete Cosine Transform) subsystem connected between the MPEG subsystem and the JPEG subsystem for transforming the input/output video/image data; a memory connected to the DCT subsystem, the MPEG subsystem, and the JPEG subsystem; in response to the MPEG/JPEG subsystem completing the first video/image processing phase of the processing of the input/output video/image data, the MPEG/JPEG subsystem stores first-MPEG/JPEG-processed data in the memory, and sends an MPEG/JPEG control signal to the DCT subsystem; in response to the MPEG/JPEG control signal, the DCT subsystem reads the first-MPEG/JPEG-processed data from the memory, transforms the first-MPEG/JPEG-processed data into transformed MPEG/JPEG data, stores the transformed MPEG/JPEG data in the memory, and sends a DCT control signal to the MPEG/JPEG subsystem; in response to the DCT control signal, the MPEG/JPEG subsystem reads the transformed MPEG/JPEG data from the memory, and performs the second video/image processing phase of the processing of the input/output video/image data.

Another embodiment of a video/image processing method for processing input/output video/image data, comprises: processing the input/output video/image data and generating first-MPEG/JPEG-processed data in a first video/image processing phase by an MPEG/JPEG subsystem; storing the first-MPEG/JPEG-processed data in a memory by the MPEG/JPEG subsystem; sending an MPEG/JPEG control signal to an DCT subsystem by the MPEG/JPEG subsystem; reading the first-MPEG/JPEG-processed data from the memory by the DCT subsystem; transforming the first-MPEG/JPEG-processed data into transformed MPEG/JPEG data by the DCT subsystem; storing the transformed MPEG/JPEG data in the memory by the DCT subsystem; sending a DCT control signal to the MPEG/JPEG subsystem by the DCT subsystem; reading the transformed MPEG/JPEG data from the memory by the MPEG/JPEG subsystem; and processing the transformed MPEG/JPEG data in a second video/image processing phase by an MPEG/JPEG subsystem.

Another embodiment of a video/image encoding method for encoding input video/image data, comprises: encoding the input video/image data and generating first-MPEG/JPEG-encoded data in a first video/image encoding phase by an MPEG/JPEG sub-encoder; storing the first-MPEG/JPEG-encoded data in a memory by the MPEG/JPEG sub-encoder; sending the MPEG/JPEG control signal to a FDCT (Forward Discrete Cosine Transform) module by the MPEG/JPEG sub-encoder; reading the first-MPEG/JPEG-encoded data from the memory by the FDCT module; transforming the first-MPEG/JPEG-encoded data into transformed MPEG/JPEG data by the FDCT module; storing the transformed MPEG/JPEG data in the memory by the FDCT module; sending a DCT control signal to the MPEG/JPEG sub-encoder by the FDCT module; reading the transformed MPEG/JPEG data from the memory by the MPEG/JPEG sub-encoder; encoding the input video/image data in a second video/image encoding phase by the MPEG/JPEG sub-encoder.

Another embodiment of a video/image decoding method for decoding output video/image data, comprises: decoding the output video/image data and generating first-MPEG/JPEG-decoded data in a first video/image decoding phase by an MPEG/JPEG sub-decoder; storing the first-MPEG/JPEG-decoded data in a memory by the MPEG/JPEG sub-decoder; sending the MPEG/JPEG control signal to an IDCT (Inverse Discrete Cosine Transform) module by the MPEG/JPEG sub-decoder; reading the first-MPEG/JPEG-decoded data from the memory by the IDCT module; transforming the first-MPEG/JPEG-decoded data into transformed MPEG/JPEG data by the IDCT module; storing the transformed MPEG/JPEG data in the memory by the IDCT module; sending a DCT control signal to the MPEG/JPEG sub-decoder by the IDCT module; reading the transformed MPEG/JPEG data from the memory by the MPEG/JPEG sub-decoder; decoding the output video/image data in a second video/image decoding phase by the MPEG/JPEG sub-decoder.

Another embodiment of a video/image processing device, comprises: a memory for storing first processed data, second processed data, discrete cosine transformed data, and inverse discrete cosine transformed data; an MPEG subsystem for processing an MPEG codec according to first input data and the discrete cosine transformed data, generating the first processed data and a first trigger signal, and storing the first processed data to the memory in response to receiving a first enable signal; a JPEG subsystem for processing JPEG codec according to second input data and the discrete cosine transformed data, generating the second processed data and a second trigger signal, and storing the second processed data to the memory in response to receiving a second enable signal; and a discrete cosine transform module coupled to the MPEG subsystem and the JPEG subsystem for transforming the first processed, data according to the first trigger signal, into one of the discrete cosine transformed data and the inverse discrete cosine transformed data, transforming the second processed data, according to the second trigger signal, into one of the discrete cosine transformed data and the inverse discrete cosine transformed data, and storing an output of the discrete cosine transform module to the memory.

### DESCRIPTION OF THE DRAWINGS

The invention will become more fully understood from the detailed description, given hereinbelow, and the accompanying drawings. The drawings and description are provided for purposes of illustration only and, thus, are not intended to be limiting of the present invention.

FIG. 1 is a schematic diagram of a conventional MPEG subsystem.

FIG. 2 is a schematic diagram of a conventional JPEG subsystem.

FIG. 3 is a schematic diagram of an embodiment of a video/image processing devices.

FIG. 4 is a schematic diagram of another embodiment of a video/image processing devices.

FIG. 5 is a flowchart of a video/image processing method for processing input/output video/image data according to embodiments of the invention.

FIG. 6 is a flowchart of a video/image encoding method for encoding input video/image data according to embodiments of the invention.

FIG. 7 is a flowchart of a video/image decoding method for decoding output video/image data according to embodiments of the invention.

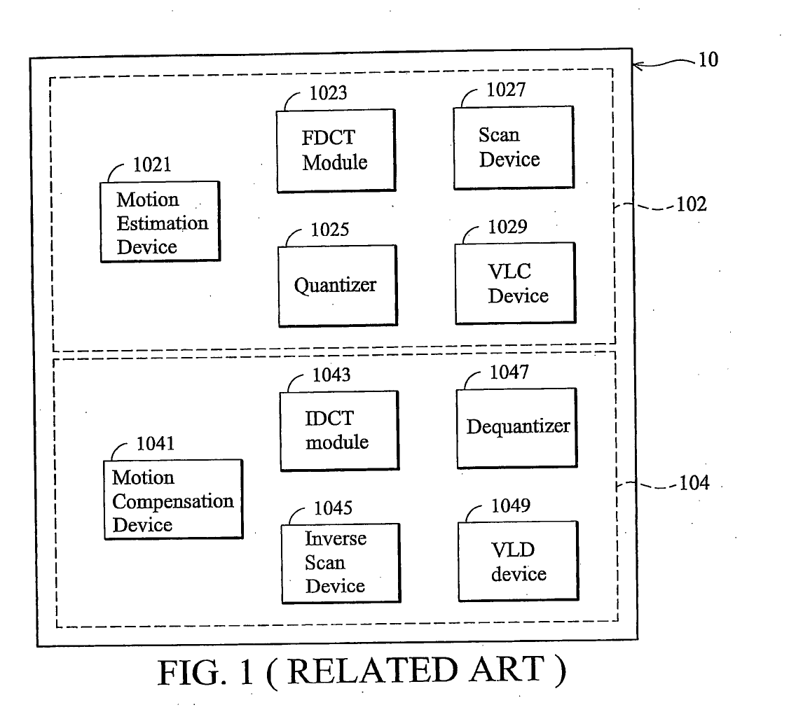

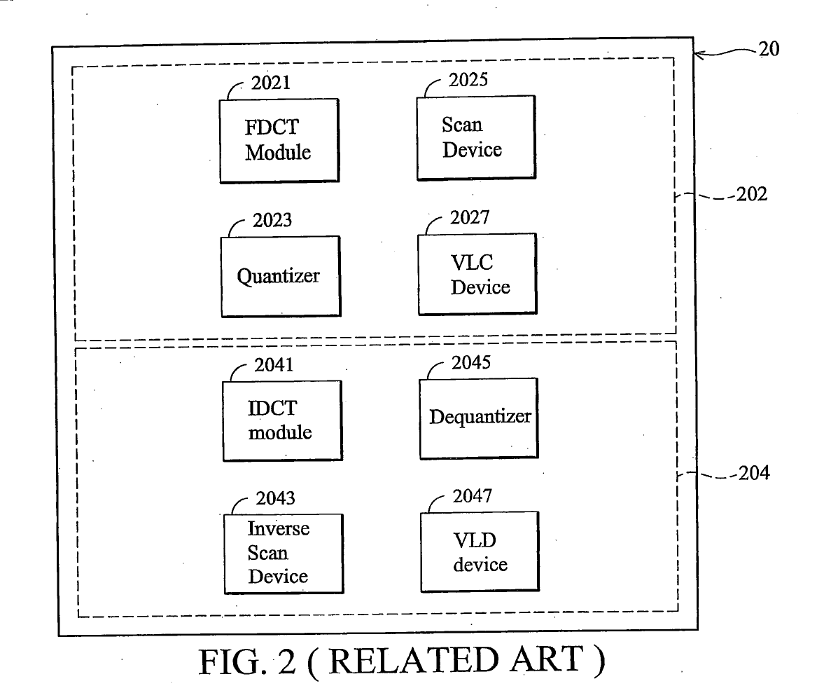

### DETAILED DESCRIPTION

Video/image processing devices are provided. Specifically, in some embodiments, an integrated discrete cosine transform (DCT) module is used to perform transformation (compression and/or decompression) of MPEG data and JPEG data. Additionally, in some embodiments, data is output to a common memory that is used to store both MPEG and JPEG data. In this manner, some embodiments potentially exhibit reduced size and/or cost compared to conventional video/image processing devices capable of performing MPEG and JPEG processing. Specifically, this can be achieved by transforming MPEG and JPEG using a common transform module, and by storing MPEG and JPEG data using a common memory.

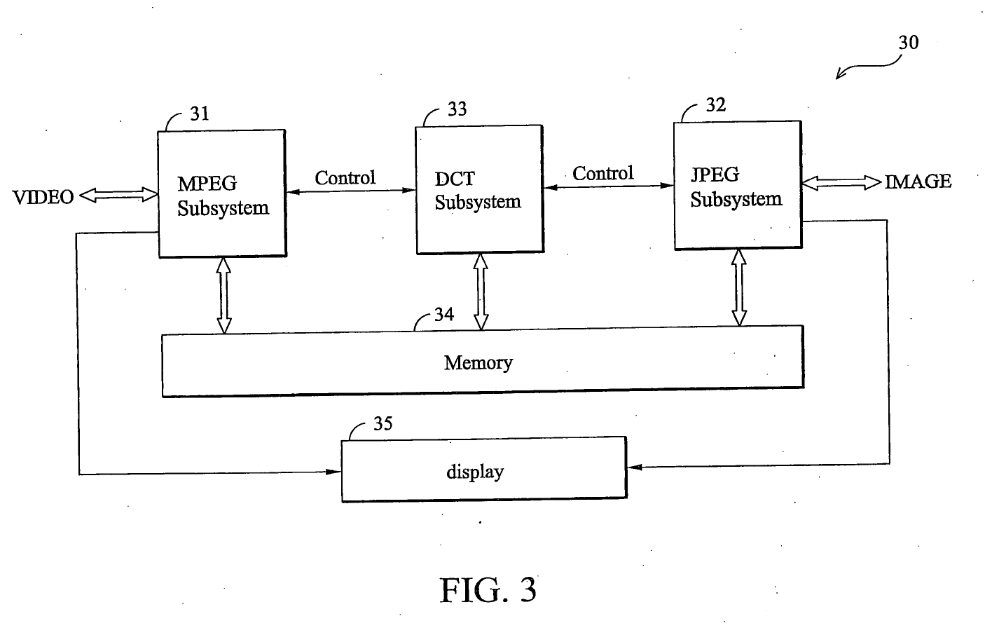

FIG. 3 is a schematic diagram of an embodiment of a video/image processing devices 30. As shown in FIG. 3, image processing device 30 incorporates an MPEG subsystem 31 and a JPEG subsystem 32 that communicate with a DCT subsystem 33. DCT subsystem 33 also communicates with memory 34. Additionally, MPEG subsystem 31 and JPEG subsystem 32 communicate with a display 35, e.g., a television or monitor, that is used to display images corresponding to the data output by the respective subsystems.

In operation, MPEG subsystem 31 processes input video data VIDEO. During discrete cosine transformation, MPEG subsystem 31 stores processed data to memory 34 and triggers DCT subsystem 33. DCT subsystem 33 accesses memory 34 and discrete cosine transforms the processed data in memory 34, then outputs control signals to MPEG subsystem 31. Next, MPEG subsystem 31 accesses the discrete cosine transformed data in memory 34 and completes MPEG compression. In addition, the MPEG compressed data is decoded by MPEG subsystem 31 with DCT subsystem 33, then outputs to display 35 for display.

JPEG subsystem 32 processes input image data IMAGE. During discrete cosine transformation, JPEG subsystem 32 stores processed data to memory 34 and triggers DCT subsystem 33. DCT subsystem 33 accesses memory 34 and discrete cosine transforms the processed data in memory 34, then outputs control signals to JPEG subsystem 32. Next, JPEG subsystem 32 accesses the discrete cosine transformed data in memory 34 and completes JPEG compression. In addition, the JPEG compressed data is decoded by JPEG subsystem 32 with DCT subsystem 33, then outputs to display 35 for display.

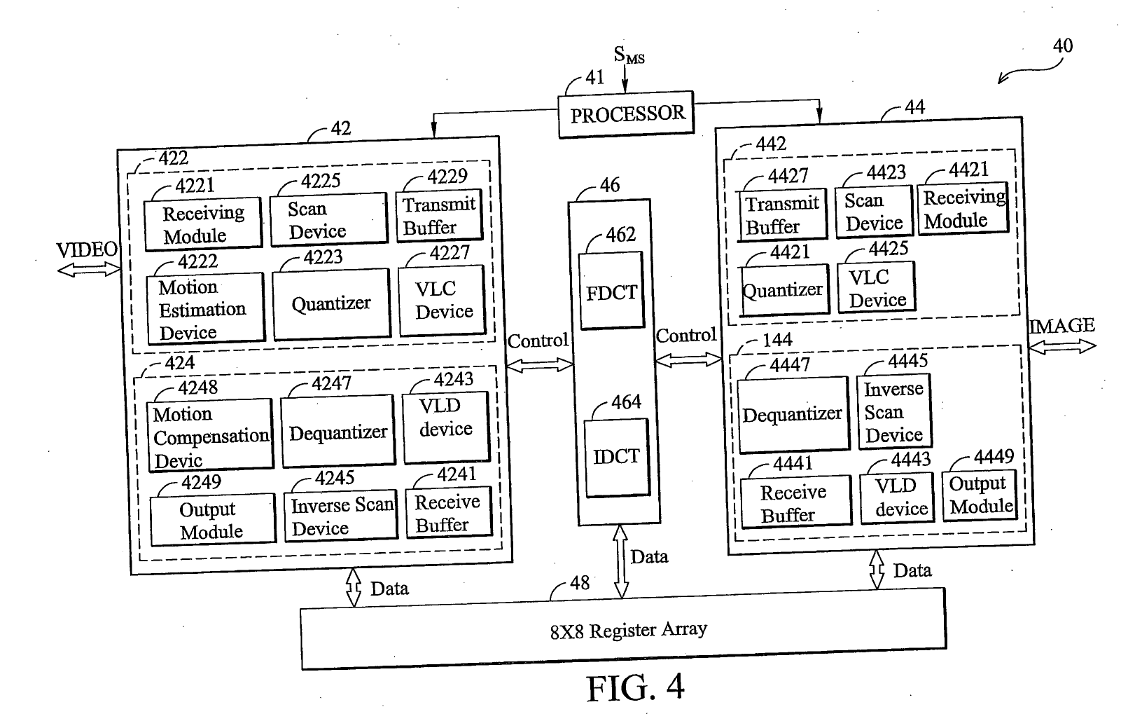

FIG. 4 is a schematic diagram of another embodiment of a video/image processing devices. As shown in FIG. 4, MPEG compression and JPEG compression is performed by image processing device 40 using a single DCT subsystem 46.

In operation, processor 41 selects an MPEG operating mode or a JPEG operating mode according to a mode selection signal Sms. In addition, as the MPEG operating mode and the JPEG operating mode are asserted simultaneously, processor 41 uses the MPEG operating mode or the JPEG operating mode according to a predetermined priority. In some embodiments, the JPEG operating mode is enabled prior to the MPEG operating mode.

The mode selection signal SMS is generated according to input from the user interface or by control signals from other hardware or software. In MPEG operating mode, processor 41 triggers MPEG subsystem 42, otherwise, in JPEG operating mode, processor 41 triggers JPEG subsystem 44.

The basic compression scheme for MPEG subsystem 42 can be summarized as follows: dividing a picture into 8×8 micro-blocks; determining relevant picture information, discarding redundant or insignificant information; and encoding relevant picture information with the least number of bits.

MPEG subsystem 42 processes a video codec for input/output of video data VIDEO with MPEG compression algorithms, such as MPEG-1, MPEG-2 and MPEG-4 standards, comprising MPEG sub-encoder 422 and MPEG sub-decoder 424. In some embodiments, MPEG subsystem 42 processes the video codec in a first video processing phase and a second video processing phase.

MPEG sub-encoder 422 comprises receiving module 4221, motion estimation device 4222, quantizer 4223, scan device 4225, variable-length coding device (VLC) 4227, and transmit buffer 4229.

In the first video processing phase, receiving module 4221 receives the input video data VIDEO. Motion estimation device 4222 estimates the input video data VIDEO and generates estimated video data. In general, successive pictures in a motion video sequence tend to be highly correlated, that is, the pictures change slightly over a small period of time. This implies that the arithmetical difference between these pictures is small. For this reason, compression ratios for motion video sequences may be increased by encoding the arithmetical difference between two or more successive frames. In contrast, objects that are in motion have increased arithmetical difference between frames which in turn implies that more bits are required to encode the sequence. To address this issue, motion estimation device 4222 is implemented to determine the displacement of an object motion estimation by which elements in a picture are best correlated to elements in other pictures (ahead or behind) by the estimated amount of motion. The amount of motion is encapsulated in the motion vector. Forward motion vectors refer to correlation with previous pictures. Backward motion vectors refer to correlation with future pictures.

When the first video processing phase is completed, MPEG sub-encoder 422 stores an image block (first-MPEG-encoded data) in memory 48, and provides MPEG control signals to trigger discrete cosine transform (DCT) subsystem 46. In some embodiments of a video/image processing devices, memory 48 can be a register array. Less access latency is required when using a register array because the register array is accessed directly without generating addressing requests. In addition, the register elements of the register array can be accessed individually, improving access efficiency. In some embodiments, memory 48 can be an 8×8 register array with 64 register elements.

DCT subsystem 46 accesses the first-MPEG-encoded data in memory 48 and processes the first-MPEG-encoded data by discrete cosine transformation using forward DCT module (FDCT) 462 to transform the first-MPEG-encoded data into transformed MPEG data. The discrete cosine transform is closely related to the discrete Fourier transform (FFT) and, as such, allows data to be represented in terms of its frequency components. In other words, in image processing applications, the two dimensional (2D) DCT maps the image block into its 2D frequency components. DCT subsystem 46 then stores the discrete cosine transformed MPEG data to memory 48, and generates DCT control signals to trigger MPEG subsystem 42.

In response to the DCT control signal, the MPEG subsystem 42 reads the transformed MPEG data from the memory 48, and performs the second video processing phase of the processing of the input video data.

Quantizer 4223 reads the transformed MPEG data from the memory 48, quantizes the transformed MPEG data, generates quantized MPEG data, and transmits the quantized MPEG data to scan device 4225. Quantizer 4223 reduces the amount of information required to represent the frequency bins of the discrete cosine transformed image block by converting amplitudes that fall in certain ranges to one in a set of quantization levels. Different quantization is applied to each coefficient depending on the spatial frequency within the block that it represents. Usually, more quantization error can be tolerated in the high-frequency coefficients, because high-frequency noise is less visible than low-frequency quantization noise. MPEG subsystem 42 uses weighting matrices to define the relative accuracy of the quantization of the different coefficients. Different weighting matrices can be used for different frames, depending on the prediction mode used. In addition, MPEG encoder 422 may comprises a feedback loop between quantizer 4223 and motion estimation device 4222. The feedback path is formed using dequantizer 4247 and IDCT 464. The dequantizer 4247 dequantizes the quantized MPEG data generated by quantizer 4223, generates corresponding dequantized data, stores the dequantized data to memory 48, and provides MPEG control signals to trigger discrete cosine transform (DCT) subsystem 46. The triggered DCT subsystem 46 accesses the dequantized data from memory 48 and processes the dequantized data into transformed MPEG data by inverse discrete cosine transformation using IDCT 464. The IDCT 464 performs inverse discrete cosine transformation by row-column decomposition for the dequantized data to generate the feedback data for estimation.

After quantization, the quantized data with DCT coefficients are scanned by scan device 4225 in a predetermined direction, for example, zigzag scanning pattern or others, to transform the 2-D array into a serial string of quantized coefficients. The coefficient strings (scanned video data) produced by the zigzag scanning are coded by counting the number of zero coefficients preceding a non-zero coefficient, i.e. run-length coded, and the Huffman coding. The run-length value, and the value of the non-zero coefficient which the run of zero coefficients precedes, are then combined and coded using a variable-length code (VLC) device 4227 to generate a compressed data. VLC device 4227 exploits the fact that short runs of zeros are more likely than long ones, and small coefficients are more likely than large ones. The VLC allocates codes which have different lengths, depending upon the expected frequency of occurrence of each zero-run-length/non-zero coefficient value combination. Common combinations use short code words; less common combinations use long code words. All other combinations are coded by the combination of an escape code and two fixed length codes, one 6-bit word to indicate the run length, and one 12-bit word to indicate the coefficient value. The compressed data is then stored to transmit buffer 4229, completing the second video encoding phase of the encoding of the input video data.

MPEG sub-decoder 424 comprises receive buffer 4241, variable-length decoding (VLD) device 4243, inverse scan device 4245, dequantizer 4247, motion compensation device 4248, and output module 4249. Generally, MPEG sub-decoder 424 processes signaling in a reverse order as compared with MPEG sub-encoder 422.

In the first video decoding phase, receive buffer 4241 provides MPEG compressed data. The MPEG compressed data can be generated by MPEG sub-encoder 422 in the MPEG encoding steps. Variable-length decoding device 4243 processes the compressed data by variable-length decoding to generate serial string data (VLD decoded data).

Inverse scan device 4245 transforms the VLD decoded data into scanned video data. Dequantizer 4247 accesses the scanned video data, and dequantizes the scanned video data to a dequantized video data. In addition, MPEG subsystem 42 stores the dequantized video data (first MPEG decoded data) in the memory 48 and generates MPEG control signals to trigger discrete cosine transform subsystem 46.

The triggered DCT subsystem 46 accesses the dequantized video data from memory 48 and processes the dequantized video data into transformed MPEG data by inverse discrete cosine transformation using inverse DCT module (IDCT) 464. The IDCT 464 transforms the dequantized video data in terms of its frequency components to its pixel components. In other words, the two dimensional (2D) DCT maps the image block into its 2D pixel components. Next, DCT subsystem 46 stores the inverse discrete cosine transformed image block (transformed MPEG data) to memory 48, and generates DCT control signals to trigger MPEG subsystem 42.

In the second video decoding phase, motion compensation device 4248 accesses the inverse discrete cosine transformed data from memory 48, compensates the discrete cosine transformed data and generates compensated MPEG data. Output module 4249 outputs the compensated MPEG data VIDEO, completing the second video encoding phase of the decoding of the output video data.

As JPEG subsystem 44, comprising JPEG encoding module 442 and JPEG decoding module 444, is triggered by processor 41, JPEG subsystem 44 processes an image codec for input/output of image data IMAGE with JPEG compression algorithms. In some embodiments, JPEG subsystem 44 processes the image codec in a first image processing phase and a second image processing phase.

JPEG sub-encoder 442 partitions each color component picture into 8×8 pixel blocks of image samples, comprising receiving module 4421, quantizer 4423, scan device 4425, variable-length coding device (VLC) 4427, and transmit buffer 4429.

In the first image processing phase, receiving module 4421 receives the input image data IMAGE. When the first image processing phase is completed, JPEG sub-encoder 442 stores first-JPEG-encoded data in memory 48, and provides JPEG control signals to trigger discrete cosine transform (DCT) subsystem 46.

DCT subsystem 46 accesses the first-JPEG-encoded data in memory 48 and processes the first-JPEG-encoded data by discrete cosine transformation using forward DCT module (FDCT) 462 to transform the first-JPEG-encoded data into transformed JPEG data. The discrete cosine transform is closely related to the discrete Fourier transform (FFT) and, as such, allows data to be represented in terms of its frequency components. In other words, in image processing applications, the two dimensional (2D) DCT maps the image block into its 2D frequency components. DCT subsystem 46 then stores the discrete cosine transformed JPEG data to memory 48, and generates DCT control signals to trigger JPEG subsystem 44.

In response to the DCT control signal, the JPEG subsystem 44 reads the transformed JPEG data from the memory 48, and performs the second image processing phase of the processing of the input image data.

Quantizer 4423 reads the transformed JPEG data from the memory 48, quantizes the transformed JPEG data, generates quantized JPEG data, and transmits the quantized JPEG data to scan device 4425. Quantizer 4423 reduces the amount of information required to represent the frequency bins of the discrete cosine transformed image block by converting amplitudes that fall in certain ranges to one in a set of quantization levels.

For quantization, JPEG subsystem 44 uses quantization matrices. JPEG subsystem 44 allows a different quantization matrix to be specified for each color component. Using quantization matrices allow each frequency bin to be quantized to a different step size. Generally the lower frequency components are quantized to a small step size and the high frequency components to a large step size. This takes advantage of the fact that the human eye is less sensitive to high frequency visual noise, but is more sensitive to lower frequency noise, manifesting itself in obstructive artifacts. Modification of the quantization matrices is the primary method for controlling JPEG quality and compression ratio. Although the quantization step size for any one of the frequency components can be modified individually, a more common technique is to scale all the elements of the matrices together.

After quantization, the quantized data with DCT coefficients are scanned by scan device 4425 in a predetermined direction, for example, zigzag scanning pattern or others, to transform the 2-D array into a serial string of quantized coefficients. The coefficient strings (scanned image data) produced by the zigzag scanning are coded by counting the number of zero coefficients preceding a non-zero coefficient, i.e. run-length coded, and the Huffman coding. The run-length value, and the value of the non-zero coefficient which the run of zero coefficients precedes, are then combined and coded using a variable-length code (VLC) device 4427 to generate a compressed data. VLC device 4427 exploits the fact that short runs of zeros are more likely than long ones, and small coefficients are more likely than large ones. The VLC allocates codes which have different lengths, depending upon the expected frequency of occurrence of each zero-run-length/non-zero coefficient value combination. Common combinations use short code words; less common combinations use long code words. All other combinations are coded by the combination of an escape code and two fixed length codes, one 6-bit word to indicate the run length, and one 12-bit word to indicate the coefficient value. The compressed data is then stored to transmit buffer 4429, completing the second image encoding phase of the encoding of the input image data.

JPEG sub-decoder 444 comprises receive buffer 4441, variable-length decoding (VLD) device 4443, inverse scan device 4445, dequantizer 4447, and output module 4449. Generally, JPEG sub-decoder 444 processes signaling in a reverse order as compared with JPEG sub-encoder 442.

In the first image decoding phase, receive buffer 4441 provides JPEG compressed data (output image data). The JPEG compressed data can be generated by JPEG sub-encoder 442 in the MPEG encoding steps. Variable-length decoding device 4443 processes the compressed data by variable-length decoding to generate a serial string data (VLD decoded data).

Inverse scan device 4445 transforms the VLD decoded data into a scanned image data. Dequantizer 4447 accesses the scanned image data, and dequantizes the scanned image data to a dequantized image data. In addition, JPEG subsystem 44 stores the dequantized image data (first JPEG decoded data) in the memory 48 and generates JPEG control signals to trigger discrete cosine transform subsystem 46.

The triggered DCT subsystem 46 accesses the dequantized image data from memory 48 and processes the dequantized image data into transformed JPEG data by inverse discrete cosine transformation using inverse DCT module (IDCT) 464. The IDCT 464 transforms the dequantized image data in terms of its frequency components to its pixel components. In other words, the two dimensional (2D) DCT maps the image block into its 2D pixel components. Next, DCT subsystem 46 stores the inverse discrete cosine transformed image block (transformed JPEG data) to memory 48, and generates DCT control signals to trigger JPEG subsystem 44.

In the second image decoding phase, output module 4449 outputs the compensated JPEG data IMAGE, completing the second image decoding phase of the decoding of the output image data.

In some embodiments, MPEG subsystem 42, JPEG subsystem 44, and DCT subsystem 46 access data from memory 48 directly. Thus, only control signals are transmitted between MPEG subsystem 42 and DCT subsystem 46, and between JPEG subsystem 44 and DCT subsystem 46.

In some embodiments, control of DCT subsystem 46 can be achieved by hardware, without using software, thus potentially improving system performance. Additionally or alternatively, some embodiments switch between employing an MPEG codec or JPEG codec while using a single DCT module, thus potentially reducing hardware cost.

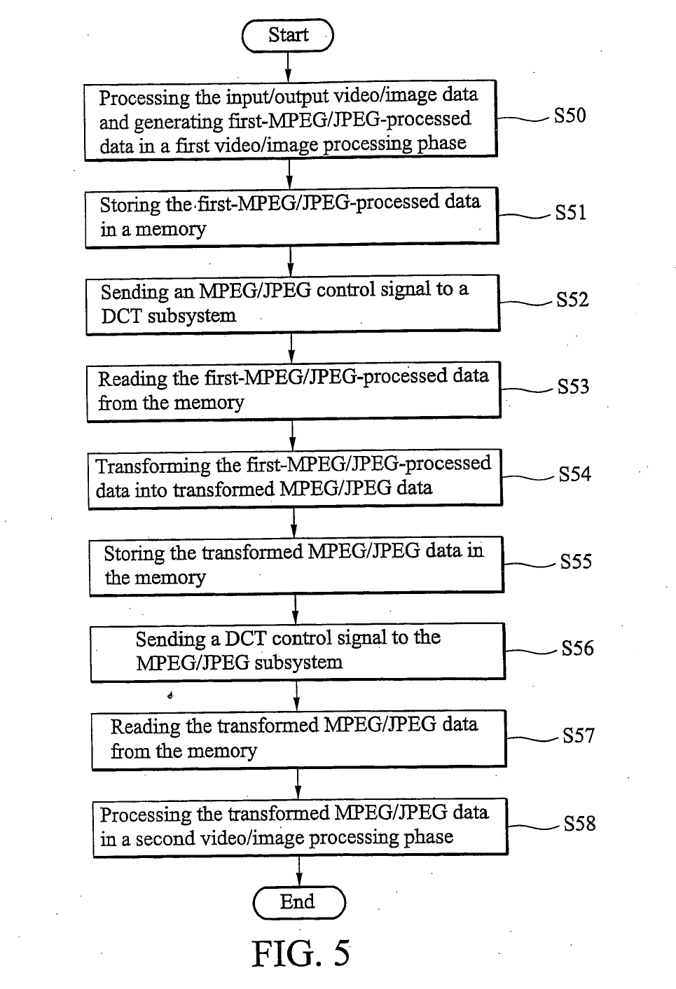

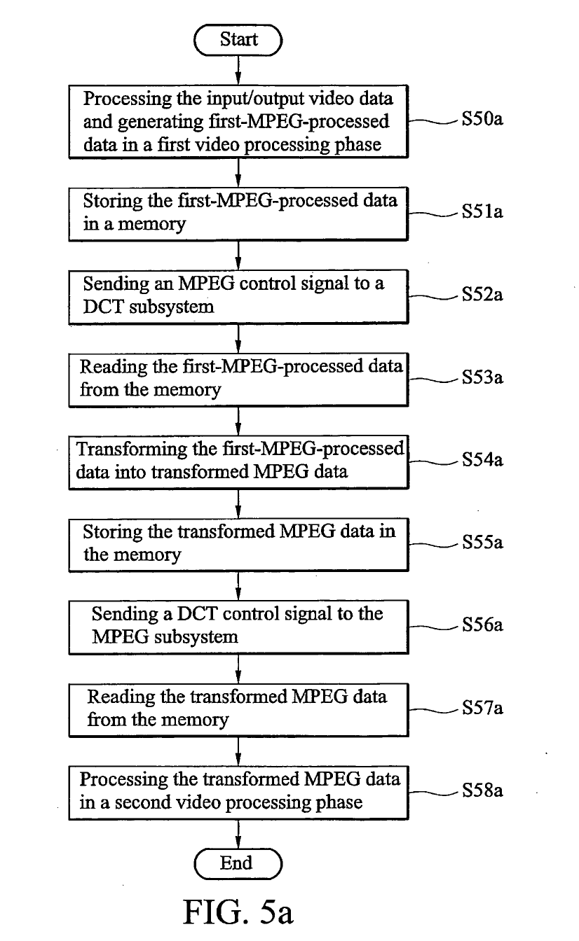

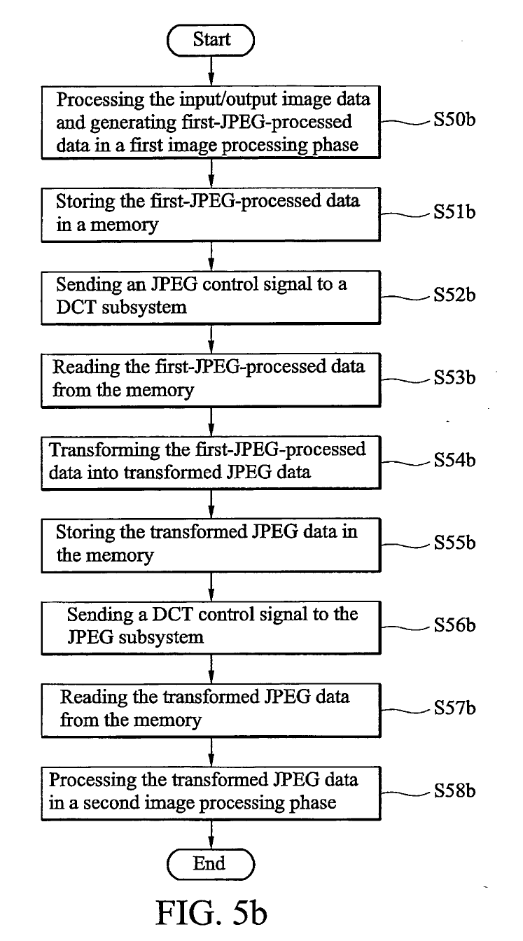

FIG. 5 is a flowchart of a video/image processing method for processing input/output video/image data according to embodiments of the invention. Here, “input/output video/image data” indicates the video/image data that can be input or output by the video/image processing method, “video/image data” represents video or image data, “MPEG/JPEG-processed data” represents MPEG-processed data or JPEG-processed data, “video/image processing phase” represents a video processing phase or an image processing phase, and “MPEG/JPEG subsystem” represents an MPEG subsystem or a JPEG subsystem.

First, the MPEG/JPEG subsystem processes the input/output video/image data and generates first-MPEG/JPEG-processed data in a first video/image processing phase (S50). Next, the MPEG/JPEG subsystem stores the first-MPEG/JPEG-processed data in a memory (S51). Next, the MPEG/JPEG subsystem sends an MPEG/JPEG control signal to a DCT (Discrete Cosine Transform) subsystem (S52). The DCT subsystem reads the first-MPEG/JPEG-processed data from the memory (S53). Next, the DCT subsystem transforms the first-MPEG/JPEG-processed data into transformed MPEG/JPEG data using discrete cosine transformation (S54). Next, the DCT subsystem stores the transformed MPEG/JPEG data in the memory (S55). Next, the DCT subsystem sends a DCT control signal to the MPEG/JPEG subsystem (S56). The MPEG/JPEG subsystem reads the transformed MPEG/JPEG data from the memory (S57). Finally, the MPEG/JPEG subsystem processes the transformed MPEG/JPEG data in a second video/image processing phase (S58).

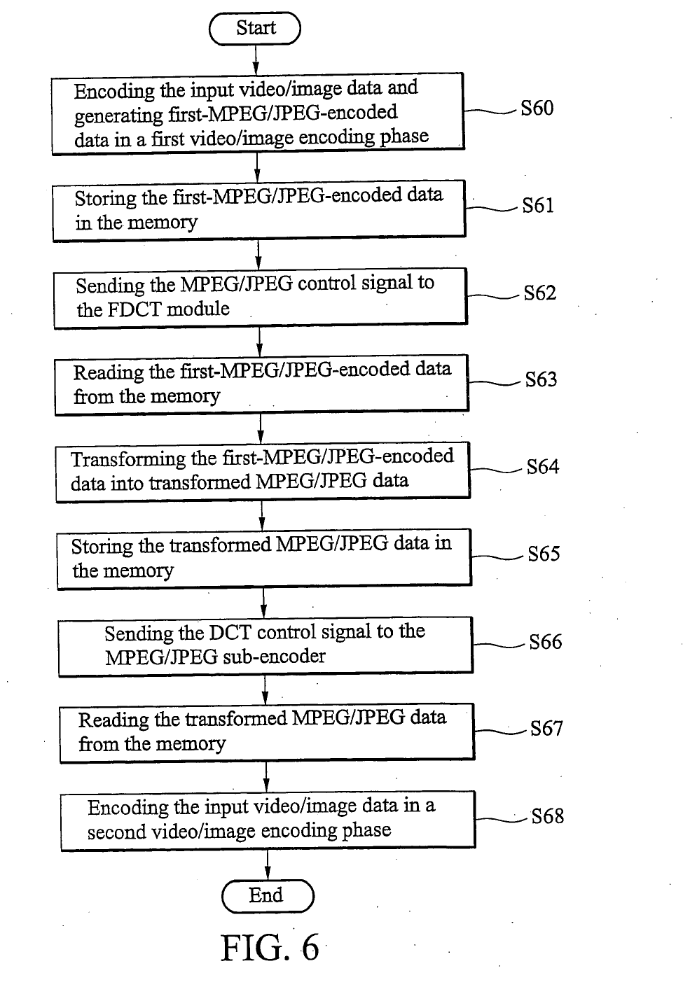

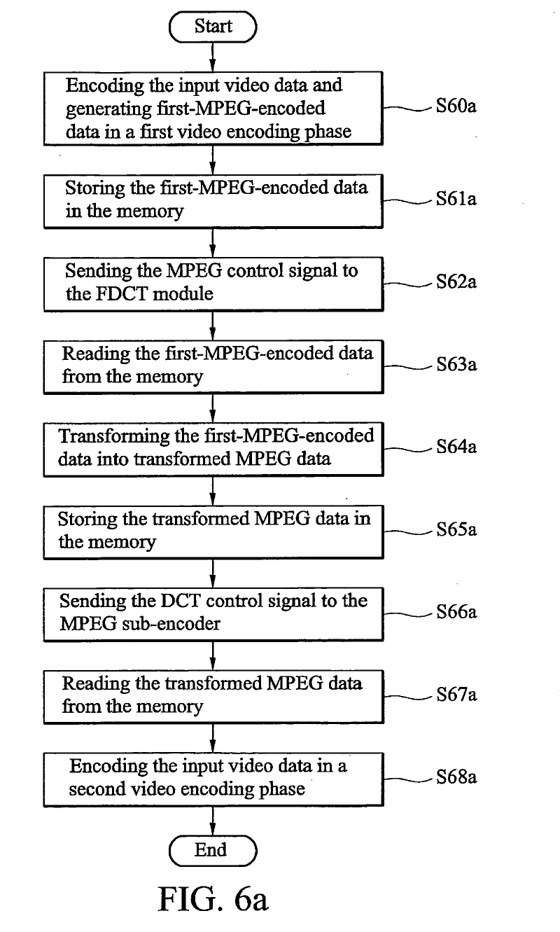

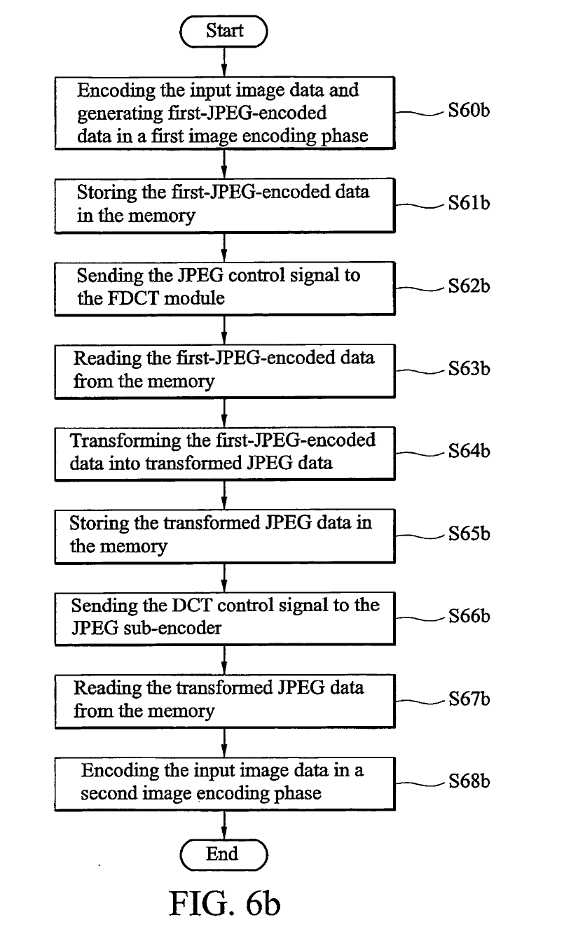

FIG. 6 is a flowchart of a video/image encoding method for encoding input video/image data according to embodiments of the invention. First, an MPEG/JPEG sub-encoder encodes the input video/image data and generates first-MPEG/JPEG-encoded data in a first video/image encoding phase (S60). Next, MPEG/JPEG sub-encoder stores the first-MPEG/JPEG-encoded data in the memory (S61). Next, the MPEG/JPEG sub-encoder sends the MPEG/JPEG control signal to the FDCT (Forward Discrete Cosine Transform) module (S62). The FDCT module reads the first-MPEG/JPEG-encoded data from the memory (S63). Next, the FDCT module transforms the first-MPEG/JPEG-encoded data into transformed MPEG/JPEG data using discrete cosine transformation (S64). Next, the FDCT module stores the transformed MPEG/JPEG data in the memory (S65). Next, the FDCT module sends the DCT control signal to the MPEG/JPEG sub-encoder (S66). The MPEG/JPEG sub-encoder reads the transformed MPEG/JPEG data from the memory (S67). Finally, the MPEG/JPEG sub-encoder encodes the input video/image data in a second video/image encoding phase (S68).

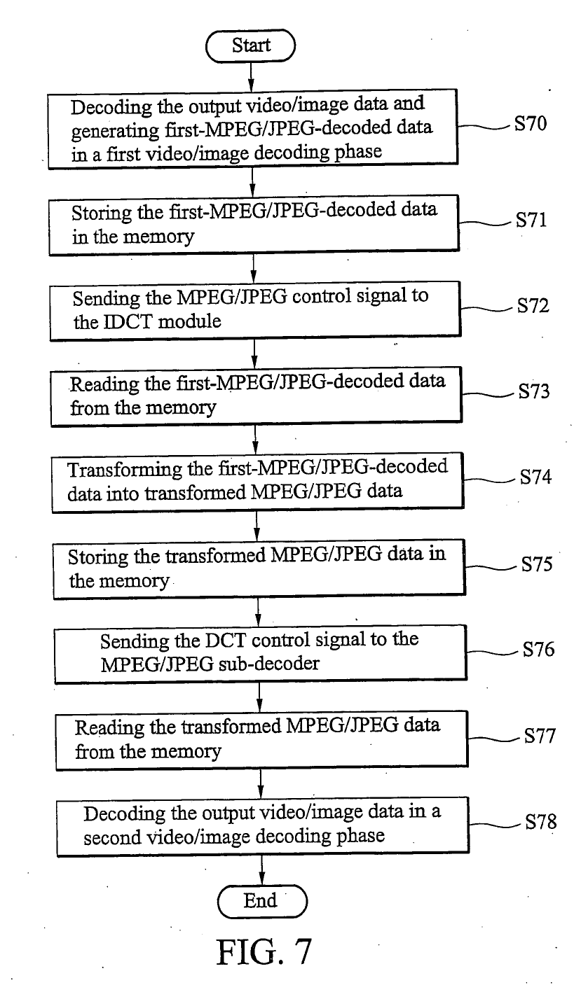

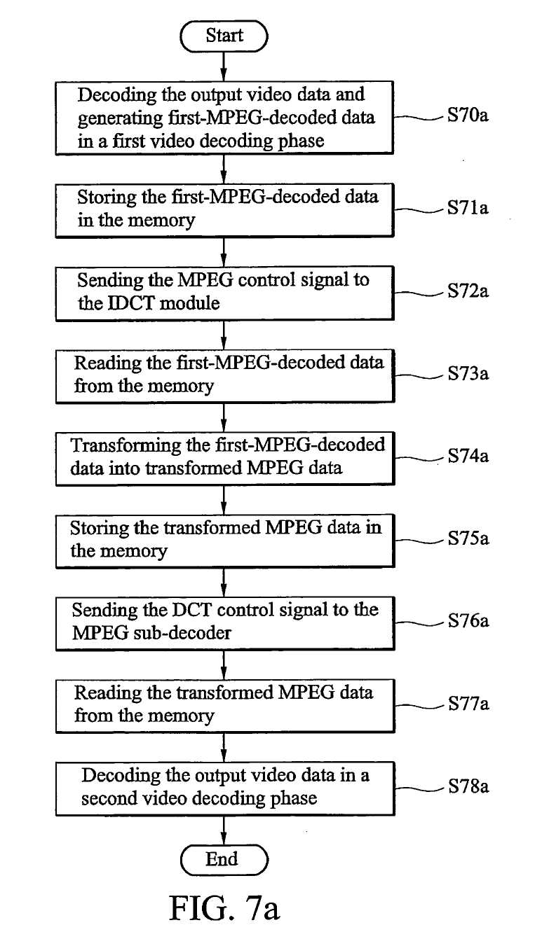

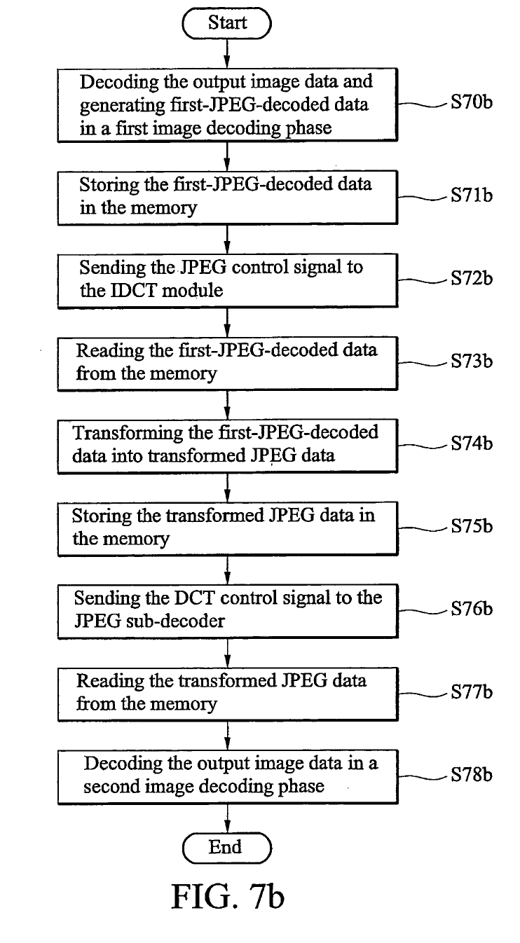

FIG. 7 is a flowchart of a video/image decoding method for decoding output video/image data according to embodiments of the invention. First, an MPEG/JPEG sub-decoder decodes the output video/image data and generates first-MPEG/JPEG-decoded data in a first video/image decoding phase (S70). Next, the MPEG/JPEG sub-decoder stores the first-MPEG/JPEG-decoded data in the memory (S71). Next, the MPEG/JPEG sub-decoder sends the MPEG/JPEG control signal to the IDCT (Inverse Discrete Cosine Transform) module (S72). The IDCT module reads the first-MPEG/JPEG-decoded data from the memory (S73). Next, the IDCT module transforms the first-MPEG/JPEG-decoded data into transformed MPEG/JPEG data using inverse discrete cosine transformation (S74). Next, the IDCT module stores the transformed MPEG/JPEG data in the memory (S75). Next, the IDCT module sends the DCT control signal to the MPEG/JPEG sub-decoder (S76). The MPEG/JPEG sub-decoder reads the transformed MPEG/JPEG data from the memory (S77). Finally, the MPEG/JPEG sub-decoder decodes the output video/image data in a second video/image decoding phase.

In some embodiments, the video/image processing devices are implemented in electronic devices, such as a DVD player, a DVD recorder, a digital camera, a cell phone or a computer, comprising a display for displaying the output video/image data.

The foregoing description of several embodiments have been presented for the purpose of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A video/image processing device for processing input video data and output video data during an MPEG mode and processing input image data and output image data during a JPEG mode, comprising:
an MPEG (Moving Pictures Expert Group) subsystem for processing the input video data and the output video data in a first video processing phase and a second video processing phase;
a JPEG (Joint Photographic Experts Group) subsystem for processing the input image data and the output image data in a first image processing phase and a second image processing phase;
a DCT (Discrete Cosine Transform) subsystem connected between the MPEG subsystem and the JPEG subsystem for transforming the input/output video/image data; and
a memory connected to the DCT subsystem, the MPEG subsystem, and the JPEG subsystem;
wherein, during the MPEG mode, in response to the MPEG subsystem completing the first video processing phase of the processing of the input video data or the output video data, the MPEG subsystem stores first-MPEG processed data in the memory, and sends an MPEG control signal to the DCT subsystem;
in response to the MPEG control signal, the DCT subsystem reads the first-MPEG processed data from the memory, transforms the first-MPEG processed data into transformed MPEG data, stores the transformed MPEG data in the memory, and sends a DCT control signal to the MPEG subsystem; and
in response to the DCT control signal, the MPEG subsystem reads the transformed MPEG data from the memory, and performs the second video processing phase of the processing of the input video data or the output video data; and
wherein, during the JPEG mode, in response to the JPEG subsystem completing the first image processing phase of the processing of the input image data or the output image data, the JPEG subsystem stores first-JPEG-processed data in the memory, and sends an JPEG control signal to the DCT subsystem;
in response to the JPEG control signal, the DCT subsystem reads the first-JPEG-processed data from the memory, transforms the first-JPEG-processed data into transformed JPEG data, stores the transformed JPEG data in the memory, and sends a DCT control signal to the JPEG subsystem; and
in response to the DCT control signal, the JPEG subsystem reads the transformed JPEG data from the memory, and performs the second image processing phase of the processing of the input image data or the output image data.

2. The video/image processing device of claim 1, wherein
the MPEG subsystem comprises an MPEG sub-encoder for encoding the input video data in a first video encoding phase and a second video encoding phase;
the JPEG subsystem comprises a JPEG sub-encoder for encoding the input image data in a first image encoding phase and a second image encoding phase;
the DCT subsystem comprises a FDCT (Forward Discrete Cosine Transform) module for transforming the input video data and the input image data;
during the MPEG mode, in response to the MPEG sub-encoder completing the first video encoding phase of the encoding of the input video data, the MPEG sub-encoder stores first-MPEG encoded data in the memory, and sends the MPEG control signal to the FDCT module;
in response to the MPEG control signal, the FDCT module reads the first-MPEG encoded data from the memory, transforms the first-MPEG encoded data into transformed MPEG data, stores the transformed MPEG data in the memory, and sends the DCT control signal to the MPEG sub-encoder; and
in response to the DCT control signal, the MPEG sub-encoder reads the transformed MPEG data from the memory, and performs the second video encoding phase of the encoding of the input video data; and
during the JPEG mode, in response to the JPEG sub-encoder completing the first image encoding phase of the encoding of the input image data, the JPEG sub-encoder stores first-JPEG-encoded data in the memory, and sends the JPEG control signal to the FDCT module;
in response to the JPEG control signal, the FDCT module reads the first-JPEG-encoded data from the memory, transforms the first-JPEG-encoded data into transformed JPEG data, stores the transformed JPEG data in the memory, and sends the DCT control signal to the JPEG sub-encoder; and
in response to the DCT control signal, the JPEG sub-encoder reads the transformed JPEG data from the memory, and performs the second image encoding phase of the encoding of the input image data.

3. The video/image processing device of claim 2, wherein the MPEG sub-encoder comprises:
a receiving module for receiving the input video data in the first video encoding phase;
a motion estimation device for estimating the input video data and generating estimated video data in the first video encoding phase;
a quantizer for quantizing the transformed MPEG data and generating quantized MPEG data in the second video encoding phase;
a Zigzag scan device for scanning the quantized MPEG data and generating scanned video data in the second video encoding phase; and
a variable-length coding (VLC) device for coding the scanned video data in the second video encoding phase;
in response to the motion estimation device completing the estimating of the input video data in the first video encoding phase, the MPEG sub-encoder stores the estimated video data in the memory, and sends the MPEG control signal to the FDCT module;
in response to the MPEG control signal, the FDCT module reads the estimated video data from the memory, transforms the estimated video data into transformed MPEG data, stores the transformed MPEG data in the memory, and sends the DCT control signal to the MPEG sub-encoder; and
in response to the DCT control signal, the quantizer reads the transformed MPEG data from the memory, quantizes the transformed MPEG data, generates the quantized MPEG data, and transmits the quantized MPEG data to the Zigzag scan device,
in response to receiving the quantized MPEG data, the Zigzag scan device scans the quantized MPEG data, generates the scanned video data, and transmits the scanned video data to the VLC device;
in response to receiving the scanned MPEG data, the VLC device codes the scanned video to complete the second video encoding phase of the encoding of the input video data.

4. The video/image processing device of claim 2, wherein the JPEG sub-encoder comprises:
a receiving module for receiving the input image data in the first image encoding phase;
a quantizer for quantizing the transformed JPEG data and generating quantized JPEG data in the second image encoding phase;
a Zigzag scan device for scanning the quantized JPEG data and generating scanned image data in the second image encoding phase; and
a variable-length coding (VLC) device for coding the scanned image data in the second image encoding phase;
in response to the receiving module completing the receiving of the input image data in the first image encoding phase, the JPEG sub-encoder stores the received input image data in the memory, and sends the JPEG control signal to the FDCT module;
in response to the JPEG control signal, the FDCT module reads the received input image data from the memory, transforms the received input image data into transformed JPEG data, stores the transformed JPEG data in the memory, and sends the DCT control signal to the JPEG sub-encoder; and
in response to the DCT control signal, the quantizer reads the transformed JPEG data from the memory, quantizes the transformed JPEG data, generates quantized JPEG data, and transmits the quantized JPEG data to the Zigzag scan device,
in response to receiving the quantized JPEG data, the Zigzag scan device scans the quantized JPEG data, generates the scanned image data, and transmits the scanned image data to the VLC device;
in response to receiving the scanned image data, the VLC device codes the scanned image data to complete the second image encoding phase of the encoding of the input image data.

5. The video/image processing device of claim 1, wherein
the MPEG subsystem comprises an MPEG sub-decoder for decoding the output video data in a first video decoding phase and a second video decoding phase;
the JPEG subsystem comprises a JPEG sub-decoder for decoding the output image data in a first image decoding phase and a second image decoding phase;
the DCT subsystem comprises a IDCT (Inverse Discrete Cosine Transform) module for transforming the output video/image data;
during the MPEG mode, in response to the MPEG sub-decoder completing the first video decoding phase of the decoding of the output video data, the MPEG sub-decoder stores first-MPEG decoded data in the memory, and sends the MPEG control signal to the IDCT module;
in response to the MPEG control signal, the IDCT module reads the first-MPEG decoded data from the memory, transforms the first-MPEG decoded data into transformed MPEG data, storing the transformed MPEG data in the memory, and sends the DCT control signal to the MPEG sub-decoder; and
in response to the DCT control signal, the MPEG sub-decoder reads the transformed MPEG data from the memory, and performs the second video decoding phase of the decoding of the output video data; and
during the JPEG mode, in response to the JPEG sub-decoder completing the first image decoding phase of the decoding of the output image data, the JPEG sub-decoder stores first-JPEG-decoded data in the memory, and sends the JPEG control signal to the IDCT module;
in response to the JPEG control signal, the IDCT module reads the first-JPEG-decoded data from the memory, transforms the first-JPEG-decoded data into transformed JPEG data, storing the transformed JPEG data in the memory, and sends the DCT control signal to the JPEG sub-decoder; and
in response to the DCT control signal, the JPEG sub-decoder reads the transformed JPEG data from the memory, and performs the second image decoding phase of the decoding of the output image data.

6. The video/image processing device of claim 5, wherein the MPEG sub-decoder comprises:
a variable-length decoder (VLD) for decoding the output video data and generating VLD decoded data in the first video decoding phase;
an inverse scan device for scanning the VLD decoded data and generating scanned video data in the first video decoding phase;
a dequantizer for dequantizing the scanned video data and generating dequantized video data in the first video decoding phase;
a motion compensation device for compensating the transformed MPEG data and generating compensated MPEG data in the second video decoding phase; and
an output module for outputting the compensated MPEG data in the second video decoding phase;
in response to the dequantizer dequantizes the scanned video data and generates the dequantized video data in the first video decoding phase, the MPEG sub-decoder stores the dequantized video data in the memory, and sends the MPEG control signal to the IDCT module;
in response to the MPEG control signal, the IDCT module reads the dequantized video data from the memory, transforms the dequantized video data into transformed MPEG data, stores the transformed MPEG data in the memory, and sends the DCT control signal to the MPEG sub-decoder; and
in response to the DCT control signal, the motion compensation device reads the transformed MPEG data from the memory, compensates the transformed MPEG data, and generates the compensated MPEG data, and the output module outputs the compensated MPEG data in the second video decoding phase.

7. The video/image processing device of claim 5, wherein the JPEG sub-decoder comprises:
a variable-length decoder (VLD) for decoding the output image data and generating VLD decoded data in the first image decoding phase;
an inverse scan device for scanning the VLD decoded data and generating scanned image data in the first image decoding phase;
a dequantizer for dequantizing the scanned image data and generating dequantized image data in the first image decoding phase; and
an output module for outputting the transformed JPEG data in the second image decoding phase;
in response to the dequantizer dequantizes the scanned image data and generates the dequantized image data in the first video decoding phase, the JPEG sub-decoder stores the dequantized image data in the memory, and sends the JPEG control signal to the IDCT module;
in response to the JPEG control signal, the IDCT module reads the dequantized image data from the memory, transforms the dequantized image data into transformed JPEG data, stores the transformed JPEG data in the memory, and sends the DCT control signal to the JPEG sub-decoder; and
in response to the DCT control signal, the output module reads the transformed JPEG data from the memory, and outputs the transformed JPEG data in the second video decoding phase.

8. The video/image processing device of claim 1, wherein the memory is an 8×8 register array.

9. A video/image encoding device for encoding input video data during an MPEG mode and encoding input image data during a JPEG mode, comprising:
an MPEG sub-encoder for encoding the input video data in a first video encoding phase and a second video encoding phase;
a JPEG sub-encoder for encoding the input image data in a first image encoding phase and a second image encoding phase;
a FDCT (Forward Discrete Cosine Transform) module for transforming the input video data and the input image data; and
a memory connected to the MPEG sub-encoder, the JPEG sub-encoder and the FDCT module;
during the MPEG mode, in response to the MPEG sub-encoder completing the first video encoding phase of the encoding of the input video data, the MPEG sub-encoder stores first-MPEG encoded data in the memory, and sends the MPEG control signal to the FDCT module;
in response to the MPEG control signal, the FDCT module reads the first-MPEG encoded data from the memory, transforms the first-MPEG encoded data into transformed MPEG data, stores the transformed MPEG data in the memory, and sends the DCT control signal to the MPEG sub-encoder; and
in response to the DCT control signal, the MPEG sub-encoder reads the transformed MPEG data from the memory, and performs the second video encoding phase of the encoding of the input video data; and
during the JPEG mode, in response to the JPEG sub-encoder completing the first image encoding phase of the encoding of the input image data, the JPEG sub-encoder stores first-JPEG-encoded data in the memory, and sends the JPEG control signal to the FDCT module;
in response to the JPEG control signal, the FDCT module reads the first-JPEG-encoded data from the memory, transforms the first-JPEG-encoded data into transformed JPEG data, stores the transformed JPEG data in the memory, and sends the DCT control signal to the JPEG sub-encoder; and
in response to the DCT control signal, the JPEG sub-encoder reads the transformed JPEG data from the memory, and performs the second image encoding phase of the encoding of the input image data.

10. The video/image encoding device of claim 9, wherein the MPEG sub-encoder comprises:
a receiving module for receiving the input video data in the first video encoding phase;
a motion estimation device for estimating the input video data and generating estimated video data in the first video encoding phase;
a quantizer for quantizing the transformed MPEG data and generating quantized MPEG data in the second video encoding phase;
a Zigzag scan device for scanning the quantized MPEG data and generating scanned video data in the second video encoding phase; and
a variable-length coding (VLC) device for coding the scanned video data in the second video encoding phase;
in response to the motion estimation device completing the estimating of the input video data in the first video encoding phase, the MPEG sub-encoder stores the estimated video data in the memory, and sends the MPEG control signal to the FDCT module;
in response to the MPEG control signal, the FDCT module reads the estimated video data from the memory, transforms the estimated video data into transformed MPEG data, stores the transformed MPEG data in the memory, and sends the DCT control signal to the MPEG sub-encoder; and
in response to the DCT control signal, the quantizer reads the transformed MPEG data from the memory, quantizes the transformed MPEG data, generates the quantized MPEG data, and transmits the quantized MPEG data to the Zigzag scan device,
in response to receiving the quantized MPEG data, the Zigzag scan device scans the quantized MPEG data, generates the scanned video data, and transmits the scanned video data to the VLC device;
in response to receiving the scanned MPEG data, the VLC device codes the scanned video to complete the second video encoding phase of the encoding of the input video data.

11. The video/image encoding device of claim 9, wherein the JPEG sub-encoder comprises:
a receiving module for receiving the input image data in the first image encoding phase;
a quantizer for quantizing the transformed JPEG data and generating quantized JPEG data in the second image encoding phase;
a Zigzag scan device for scanning the quantized JPEG data and generating scanned image data in the second image encoding phase; and
a variable-length coding (VLC) device for coding the scanned image data in the second image encoding phase;
in response to the receiving module completing the receiving of the input image data in the first image encoding phase, the JPEG sub-encoder stores the received input image data in the memory, and sends the JPEG control signal to the FDCT module;
in response to the JPEG control signal, the FDCT module reads the received input image data from the memory, transforms the received input image data into transformed JPEG data, stores the transformed JPEG data in the memory, and sends the DCT control signal to the JPEG sub-encoder; and
in response to the DCT control signal, the quantizer reads the transformed JPEG data from the memory, quantizes the transformed JPEG data, generates quantized JPEG data, and transmits the quantized JPEG data to the Zigzag scan device,
in response to receiving the quantized JPEG data, the Zigzag scan device scans the quantized JPEG data, generates the scanned image data, and transmits the scanned image data to the VLC device;
in response to receiving the scanned image data, the VLC device codes the scanned image data to complete the second image encoding phase of the encoding of the input image data.

12. The video/image encoding device of claim 9, wherein the memory is an 8×8 register array.

13. A video/image decoding device for decoding output video data during an MPEG mode and decoding output image data during a JPEG mode, comprising:
an MPEG sub-decoder for decoding the output video data in a first video decoding phase and a second video decoding phase;
a JPEG sub-decoder for decoding the output image data in a first image decoding phase and a second image decoding phase;
an IDCT (Inverse Discrete Cosine Transform) module for transforming the output video data and the output image data; and
a memory connected to the MPEG sub-decoder, the JPEG sub-decoder and the IDCT module;
during the MPEG mode, in response to the MPEG sub-decoder completing the first video decoding phase of the decoding of the output video data, the MPEG sub-decoder stores first-MPEG decoded data in the memory, and sends the MPEG control signal to the IDCT module;
in response to the MPEG control signal, the IDCT module reads the first-MPEG decoded data from the memory, transforms the first-MPEG decoded data into transformed MPEG data, storing the transformed MPEG data in the memory, and sends the DCT control signal to the MPEG sub-decoder; and
during the JPEG mode, in response to the DCT control signal, the JPEG sub-decoder reads the transformed JPEG data from the memory, and performs the second image decoding phase of the decoding of the output image data;
in response to the JPEG sub-decoder completing the first image decoding phase of the decoding of the output image data, the JPEG sub-decoder stores first-JPEG-decoded data in the memory, and sends the JPEG control signal to the IDCT module;
in response to the JPEG control signal the IDCT module reads the first-JPEG-decoded data from the memory, transforms the first-JPEG-decoded data into transformed JPEG data, storing the transformed JPEG data in the memory, and sends the DCT control signal to the JPEG sub-decoder; and
in response to the DCT control signal, the JPEG sub-decoder reads the transformed JPEG data from the memory, and performs the second image decoding phase of the decoding of the output image data.

14. The video/image decoding device of claim 13, wherein the MPEG sub-decoder comprises:
a variable-length decoder (VLD) for decoding the output video data and generating VLD decoded data in the first video decoding phase;
an inverse scan device for scanning the VLD decoded data and generating scanned video data in the first video decoding phase;
a dequantizer for dequantizing the scanned video data and generating dequantized video data in the first video decoding phase;
a motion compensation device for compensating the transformed MPEG data and generating compensated MPEG data in the second video decoding phase; and
an output module for outputting the compensated MPEG data in the second video decoding phase;
in response to the dequantizer dequantizes the scanned video data and generates the dequantized video data in the first video decoding phase, the MPEG sub-decoder stores the dequantized video data in the memory, and sends the MPEG control signal to the IDCT module;
in response to the MPEG control signal, the IDCT module reads the dequantized video data from the memory, transforms the dequantized video data into transformed MPEG data, stores the transformed MPEG data in the memory, and sends the DCT control signal to the MPEG sub-decoder; and
in response to the DCT control signal, the motion compensation device reads the transformed MPEG data from the memory, compensates the transformed MPEG data, and generates the compensated MPEG data, and the output module outputs the compensated MPEG data in the second video decoding phase.

15. The video/image decoding device of claim 13, wherein the JPEG sub-decoder comprises:
a variable-length decoder (VLD) for decoding the output image data and generating VLD decoded data in the first image decoding phase;
an inverse scan device for scanning the VLD decoded data and generating scanned image data in the first image decoding phase;
a dequantizer for dequantizing the scanned image data and generating dequantized image data in the first image decoding phase; and
an output module for outputting the transformed JPEG data in the second image decoding phase;
in response to the dequantizer dequantizes the scanned image data and generates the dequantized image data in the first video decoding phase, the JPEG sub-decoder stores the dequantized image data in the memory, and sends the JPEG control signal to the IDCT module;
in response to the JPEG control signal, the IDCT module reads the dequantized image data from the memory, transforms the dequantized image data into transformed JPEG data, stores the transformed JPEG data in the memory, and sends the DCT control signal to the JPEG sub-decoder; and
in response to the DCT control signal, the output module reads the transformed JPEG data from the memory, and outputs the transformed JPEG data in the second video decoding phase.

16. The video/image decoding device of claim 13, wherein the memory is an 8×8 register array.

17. An electronic device for processing input video data, input image data, output video data, and output image data, comprising:
a video/image processing device operating during an MPEG mode and a JPEG mode, comprising:
an MPEG (Moving Pictures Expert Group) subsystem for processing the input video data and the output video data in a first video processing phase and a second video processing phase;
a JPEG (Joint Photographic Experts Group) subsystem for processing the input image data and the output image data in a first image processing phase and a second image processing phase;
a DCT (Discrete Cosine Transform) subsystem connected between the MPEG subsystem and the JPEG subsystem for transforming the input video data, the input image data, the output video data, and the output image data; and
a memory connected to the DCT subsystem, the MPEG subsystem, and the JPEG subsystem;
wherein during the MPEG mode, in response to the MPEG subsystem completing the first video processing phase of the processing of the input video data or the output video data the MPEG subsystem stores first-MPEG processed data in the memory, and sends an MPEG control signal to the DCT subsystem;
in response to the MPEG control signal, the DCT subsystem reads the first-MPEG processed data from the memory, transforms the first-MPEG processed data into transformed MPEG data, stores the transformed MPEG data in the memory, and sends a DCT control signal to the MPEG subsystem; and
in response to the DCT control signal, the MPEG subsystem reads the transformed MPEG data from the memory, and performs the second video processing phase of the processing of the input video data or the output video data; and
wherein during the JPEG mode, in response to the JPEG subsystem completing the first image processing phase of the processing of the input image data or the output image data, the JPEG subsystem stores first-JPEG-processed data in the memory, and sends an JPEG control signal to the DCT subsystem;
in response to the JPEG control signal, the DCT subsystem reads the first-JPEG-processed data from the memory transforms the first-JPEG-processed data into transformed JPEG data, stores the transformed JPEG data in the memory, and sends a DCT control signal to the JPEG subsystem; and
in response to the DCT control signal, the JPEG subsystem reads the transformed JPEG data from the memory, and performs the second image processing phase of the processing of the input image data or the output image data.

18. The electronic device of claim 17, further comprising a display for displaying the output video data or the output image data.

19. The electronic device of claim 17, wherein
the MPEG subsystem comprises an MPEG sub-encoder for encoding the input video data in a first video encoding phase and a second video encoding phase;
the JPEG subsystem comprises a JPEG sub-encoder for encoding the input image data in a first image encoding phase and a second image encoding phase;
the DCT subsystem comprises a FDCT (Forward Discrete Cosine Transform) module for transforming the input video data and the input image data;
during the MPEG mode, in response to the MPEG sub-encoder completing the first video encoding phase of the encoding of the input video data, the MPEG sub-encoder stores first-MPEG encoded data in the memory, and sends the MPEG control signal to the FDCT module;
in response to the MPEG control signal, the FDCT module reads the first-MPEG encoded data from the memory, transforms the first-MPEG encoded data into transformed MPEG data, stores the transformed MPEG data in the memory, and sends the DCT control signal to the MPEG sub-encoder; and
in response to the DCT control signal, the MPEG sub-encoder reads the transformed MPEG data from the memory, and performs the second video encoding phase of the encoding of the input video data; and
during the JPEG mode, in response to the JPEG sub-encoder completing the first image encoding phase of the encoding of the input image data, the JPEG sub-encoder stores first-JPEG-encoded data in the memory, and sends the JPEG control signal to the FDCT module;
in response to the JPEG control signal, the FDCT module reads the first-JPEG-encoded data from the memory, transforms the first-JPEG-encoded data into transformed JPEG data, stores the transformed JPEG data in the memory, and sends the DCT control signal to the JPEG sub-encoder; and
in response to the DCT control signal, the JPEG sub-encoder reads the transformed JPEG data from the memory, and performs the second image encoding phase of the encoding of the input image data.

20. The electronic device of claim 19, wherein the MPEG sub-encoder comprises:
a receiving module for receiving the input video data in the first video encoding phase;
a motion estimation device for estimating the input video data and generating estimated video data in the first video encoding phase;
a quantizer for quantizing the transformed MPEG data and generating quantized MPEG data in the second video encoding phase;
a Zigzag scan device for scanning the quantized MPEG data and generating scanned video data in the second video encoding phase; and
a variable-length coding (VLC) device for coding the scanned video data in the second video encoding phase;
in response to the motion estimation device completing the estimating of the input video data in the first video encoding phase, the MPEG sub-encoder stores the estimated video data in the memory, and sends the MPEG control signal to the FDCT module;
in response to the MPEG control signal, the FDCT module reads the estimated video data from the memory, transforms the estimated video data into transformed MPEG data, stores the transformed MPEG data in the memory, and sends the DCT control signal to the MPEG sub-encoder; and
in response to the DCT control signal, the quantizer reads the transformed MPEG data from the memory, quantizes the transformed MPEG data, generates the quantized MPEG data, and transmits the quantized MPEG data to the Zigzag scan device,
in response to receiving the quantized MPEG data, the Zigzag scan device scans the quantized MPEG data, generates the scanned video data, and transmits the scanned video data to the VLC device;
in response to receiving the scanned MPEG data, the VLC device codes the scanned video to complete the second video encoding phase of the encoding of the input video data.

21. The electronic device of claim 19, wherein the JPEG sub-encoder comprises:
a receiving module for receiving the input image data in the first image encoding phase;
a quantizer for quantizing the transformed JPEG data and generating quantized JPEG data in the second image encoding phase;
a Zigzag scan device for scanning the quantized JPEG data and generating scanned image data in the second image encoding phase; and
a variable-length coding (VLC) device for coding the scanned image data in the second image encoding phase;
in response to the receiving module completing the receiving of the input image data in the first image encoding phase, the JPEG sub-encoder stores the received input image data in the memory, and sends the JPEG control signal to the FDCT module;
in response to the JPEG control signal, the FDCT module reads the received input image data from the memory, transforms the received input image data into transformed JPEG data, stores the transformed JPEG data in the memory, and sends the DCT control signal to the JPEG sub-encoder; and
in response to the DCT control signal, the quantizer reads the transformed JPEG data from the memory, quantizes the transformed JPEG data, generates quantized JPEG data, and transmits the quantized JPEG data to the Zigzag scan device,
in response to receiving the quantized JPEG data, the Zigzag scan device scans the quantized JPEG data, generates the scanned image data, and transmits the scanned image data to the VLC device;
in response to receiving the scanned image data, the VLC device codes the scanned image data to complete the second image encoding phase of the encoding of the input image data.

22. The electronic device of claim 17, wherein
the MPEG subsystem comprises an MPEG sub-decoder for decoding the output video data in a first video decoding phase and a second video decoding phase;
the JPEG subsystem comprises a JPEG sub-decoder for decoding the output image data in a first image decoding phase and a second image decoding phase;
the DCT subsystem comprises a IDCT (Inverse Discrete Cosine Transform) module for transforming the output video data and the output image data;
during the MPEG mode, in response to the MPEG sub-decoder completing the first video decoding phase of the decoding of the output video data, the MPEG sub-decoder stores first-MPEG decoded data in the memory, and sends the MPEG control signal to the IDCT module;
in response to the MPEG control signal, the IDCT module reads the first-MPEG decoded data from the memory, transforms the first-MPEG decoded data into transformed MPEG data, storing the transformed MPEG data in the memory, and sends the DCT control signal to the MPEG sub-decoder; and
in response to the DCT control signal, the MPEG sub-decoder reads the transformed MPEG data from the memory, and performs the second video decoding phase of the decoding of the output video data; and
during the JPEG mode, in response to the JPEG sub-decoder completing the first image decoding phase of the decoding of the output image data, the JPEG sub-decoder stores first-JPEG-decoded data in the memory, and sends the JPEG control signal to the IDCT module;
in response to the JPEG control signal, the IDCT module reads the first-JPEG-decoded data from the memory, transforms the first-JPEG-decoded data into transformed JPEG data, storing the transformed JPEG data in the memory, and sends the DCT control signal to the JPEG sub-decoder; and
in response to the DCT control signal, the JPEG sub-decoder reads the transformed JPEG data from the memory, and performs the second image decoding phase of the decoding of the output image data.

23. The electronic device of claim 22, wherein the MPEG sub-decoder comprises:
a variable-length decoder (VLD) for decoding the output video data and generating VLD decoded data in the first video decoding phase;
an inverse scan device for scanning the VLD decoded data and generating scanned video data in the first video decoding phase;
a dequantizer for dequantizing the scanned video data and generating dequantized video data in the first video decoding phase;
a motion compensation device for compensating the transformed MPEG data and generating compensated MPEG data in the second video decoding phase; and
an output module for outputting the compensated MPEG data in the second video decoding phase;
in response to the dequantizer dequantizes the scanned video data and generates the dequantized video data in the first video decoding phase, the MPEG sub-decoder stores the dequantized video data in the memory, and sends the MPEG control signal to the IDCT module;
in response to the MPEG control signal, the IDCT module reads the dequantized video data from the memory, transforms the dequantized video data into transformed MPEG data, stores the transformed MPEG data in the memory, and sends the DCT control signal to the MPEG sub-decoder; and
in response to the DCT control signal, the motion compensation device reads the transformed MPEG data from the memory, compensates the transformed MPEG data, and generates the compensated MPEG data, and the output module outputs the compensated MPEG data in the second video decoding phase.

24. The electronic device of claim 22, wherein the JPEG sub-decoder comprises:
a variable-length decoder (VLD) for decoding the output image data and generating VLD decoded data in the first image decoding phase;
an inverse scan device for scanning the VLD decoded data and generating scanned image data in the first image decoding phase;
a dequantizer for dequantizing the scanned image data and generating dequantized image data in the first image decoding phase; and
an output module for outputting the transformed JPEG data in the second image decoding phase;
in response to the dequantizer dequantizes the scanned image data and generates the dequantized image data in the first video decoding phase, the JPEG sub-decoder stores the dequantized image data in the memory, and sends the JPEG control signal to the IDCT module;
in response to the JPEG control signal, the IDCT module reads the dequantized image data from the memory, transforms the dequantized image data into transformed JPEG data, stores the transformed JPEG data in the memory, and sends the DCT control signal to the JPEG sub-decoder; and
in response to the DCT control signal, the output module reads the transformed JPEG data from the memory, and outputs the transformed JPEG data in the second video decoding phase.

25. The electronic device of claim 17, wherein the memory is an 8×8 register array.

26. The electronic device of claim 17, wherein the electronic device is a DVD player, a DVD recorder, a digital camera, a cell phone, a PDA, or a computer.

27. A video/image processing method for processing input video data and output video data during an MPEG mode and processing input image data and output image data during a JPEG mode,
during the MPEG mode the video/image processing method comprising:
processing the input video data or the output video data and generating first-MPEG processed data in a first video processing phase by an MPEG subsystem;
storing the first-MPEG processed data in a memory by the MPEG subsystem;
sending an MPEG control signal to a DCT subsystem by the MPEG subsystem;
reading the first-MPEG processed data from the memory by the DCT subsystem;
transforming the first-MPEG processed data into transformed MPEG data by the DCT subsystem;
storing the transformed MPEG data in the memory by the DCT subsystem;
sending a DCT control signal to the MPEG subsystem by the DCT subsystem;
reading the transformed MPEG data from the memory by the MPEG subsystem; and
processing the transformed MPEG data in a second video processing phase by the MPEG subsystem; and
during the JPEG mode the video/image processing method comprising:
processing the input image data or the output image data and generating first-JPEG-processed data in a first image processing phase by an JPEG subsystem;
storing the first-JPEG-processed data in a memory by the JPEG subsystem;
sending an JPEG control signal to a DCT subsystem by the JPEG subsystem;
reading the first-JPEG-processed data from the memory by the DCT subsystem;
transforming the first-JPEG-processed data into transformed JPEG data by the DCT subsystem;
storing the transformed JPEG data in the memory by the DCT subsystem;
sending a DCT control signal to the JPEG subsystem by the DCT subsystem;
reading the transformed JPEG data from the memory by the JPEG subsystem; and
processing the transformed JPEG data in a second image processing phase by the JPEG subsystem.

28. The video/image processing method of claim 27, wherein the video/image processing method comprises a video/image encoding process, the MPEG/JPEG subsystem comprises an MPEG/JPEG sub-encoder and the DCT subsystem comprises a FDCT (Forward Discrete Cosine Transform) module,
during the MPEG mode, the video/image encoding process comprises:
encoding the input video data and generating first-MPEG encoded data in a first video encoding phase by the MPEG sub-encoder;
storing the first-MPEG encoded data in the memory by the MPEG sub-encoder;
sending the MPEG control signal to the FDCT module by the MPEG sub-encoder;
reading the first-MPEG encoded data from the memory by the FDCT module;
transforming the first-MPEG encoded data into transformed MPEG data by the FDCT module;
storing the transformed MPEG data in the memory by the FDCT module;
sending the DCT control signal to the MPEG sub-encoder by the FDCT module;
reading the transformed MPEG data from the memory by the MPEG sub-encoder; and
encoding the input video data in a second video encoding phase by the MPEG sub-encoder; and
during the JPEG mode, the video/image encoding process comprises:
encoding the input image data and generating first-JPEG-encoded data in a first image encoding phase by the JPEG sub-encoder:
storing the first-JPEG-encoded data in the memory by the JPEG sub-encoder;
sending the JPEG control signal to the FDCT module by the JPEG sub-encoder;
reading the first-JPEG-encoded data from the memory by the FDCT module;
transforming the first-JPEG-encoded data into transformed JPEG data by the FDCT module;
storing the transformed JPEG data in the memory by the FDCT module;
sending the DCT control signal to the JPEG sub-encoder by the FDCT module;
reading the transformed JPEG data from the memory by the JPEG sub-encoder; and
encoding the input image data in a second image encoding phase by the JPEG sub-encoder.

29. The video/image processing method of claim 28, wherein the MPEG sub-encoder comprises a receiving module, a motion estimation device, a quantizer, a Zigzag scan device, and a variable-length coding (VLC) device, and during the MPEG mode, the video encoding process comprises:
receiving the input video data in the first video encoding phase by the receiving module;
estimating the input video data and generating estimated video data in the first video encoding phase by the motion estimation device;
storing the estimated video data in the memory by the MPEG sub-encoder;
sending the MPEG control signal to the FDCT module by the MPEG sub-encoder;
reading the estimated video data from the memory by the FDCT module;
transforming the estimated video data into transformed MPEG data by the FDCT module;
storing the transformed MPEG data in the memory by the FDCT module;
sending the DCT control signal to the MPEG sub-encoder by the FDCT module;
reading the transformed MPEG data from the memory in the second video encoding phase by the quantizer;
quantizing the transformed MPEG data and generates the quantized MPEG data in the second video encoding phase by the quantizer;
transmitting the quantized MPEG data to the Zigzag scan device in the second video encoding phase by the quantizer;
scanning the quantized MPEG data and generating the scanned video data in the second video encoding phase by the Zigzag scan device;
transmitting the scanned video data to the VLC device in the second video encoding phase by the Zigzag scan device; and
coding the scanned video data in the second video encoding phase by the VLC device.

30. The video/image processing method of claim 28, wherein the JPEG sub-encoder comprises a receiving module, a quantizer, a Zigzag scan device, and a variable-length coding (VLC) device, and during the JPEG mode the image encoding process comprises:
receiving the input image data in the first image encoding phase by the receiving module;
storing the input image data in the memory by the JPEG sub-encoder;
sending the JPEG control signal to the FDCT module by the JPEG sub-encoder;
reading the received input image data from the memory by the FDCT module;
transforming the received input image data into transformed JPEG data by the FDCT module;
storing the transformed JPEG data in the memory by the FDCT module;
sending the DCT control signal to the JPEG sub-encoder by the FDCT module;
reading the transformed JPEG data from the memory in the second image encoding phase by the quantizer;
quantizing the transformed JPEG data and generates the quantized JPEG data in the second image encoding phase by the quantizer;
transmitting the quantized JPEG data to the Zigzag scan device in the second image encoding phase by the quantizer;
scanning the quantized JPEG data and generating the scanned image data in the second image encoding phase by the Zigzag scan device;
transmitting the scanned image data to the VLC device in the second image encoding phase by the Zigzag scan device; and
coding the scanned image data in the second image encoding phase by the VLC device.

31. The video/image processing method of claim 27, wherein the video/image processing method comprises a video decoding process and an image decoding process, the MPEG/JPEG subsystem comprises an MPEG/JPEG sub-decoder and the DCT subsystem comprises an IDCT (Inverse Discrete Cosine Transform) module,
the video decoding process comprises:
decoding the output video data and generating first-MPEG decoded data in
a first video decoding phase by the MPEG sub-decoder;
storing the first-MPEG decoded data in the memory by the MPEG sub-decoder;
sending the MPEG control signal to the IDCT module by the MPEG sub-decoder;
reading the first-MPEG decoded data from the memory by the IDCT module;
transforming the first-MPEG decoded data into transformed MPEG data by the IDCT module;
storing the transformed MPEG data in the memory by the IDCT module;
sending the DCT control signal to the MPEG sub-decoder by the IDCT module;
reading the transformed MPEG data from the memory by the MPEG sub-decoder; and
decoding the output video data in a second video decoding phase by the MPEG sub-decoder; and
the image decoding process comprises:
decoding the output image data and generating first-JPEG-decoded data in a first image decoding phase by the JPEG sub-decoder;
storing the first-JPEG-decoded data in the memory by the JPEG sub-decoder;
sending the JPEG control signal to the IDCT module by the JPEG sub-decoder;
reading the first-JPEG-decoded data from the memory by the IDCT module;
transforming the first-JPEG-decoded data into transformed JPEG data by the IDCT module;
storing the transformed JPEG data in the memory by the IDCT module;
sending the DCT control signal to the JPEG sub-decoder by the IDCT module;
reading the transformed JPEG data from the memory by the JPEG sub-decoder; and
decoding the output image data in a second image decoding phase by the JPEG sub-decoder.

32. The video/image processing method of claim 31, wherein the MPEG sub-decoder comprises a variable-length decoding (VLD) device, an inverse scan device, a dequantizer, a motion compensation device, and an output module, and the video decoding process comprises:
coding the output video data and generating VLD decoded data in the first video decoding phase by the VLD device;
transmitting the VLD decoded data to the inverse scan device in the first video decoding phase by the VLD device;
scanning the VLD decoded data and generating scanned video data in the first video decoding phase by the inverse scan device;
transmitting the scanned video data to the dequantizer in the first video decoding phase by the inverse scan device;
dequantizing the scanned video data and generating dequantized video data in the first video decoding phase by the dequantizer;
storing the dequantized video data in the memory by the MPEG sub-decoder;
sending the MPEG control signal to the IDCT module by the MPEG sub-decoder;
reading the dequantized video data from the memory by the IDCT module;
transforming the dequantized video data into transformed MPEG data by the IDCT module;
storing the transformed MPEG data in the memory by the IDCT module;
sending the DCT control signal to the MPEG sub-decoder by the IDCT module;
reading the transformed MPEG data from the memory in the second video decoding phase by the motion compensation device;
compensating the transformed MPEG data and generating the compensated MPEG data in the second video decoding phase by the motion compensation device; and
outputting the compensated MPEG data in the second video decoding phase by the output module.

33. The video/image processing method of claim 31, wherein the JPEG sub-decoder comprises a variable-length decoding (VLD) device, an inverse scan device, a dequantizer, and an output module, and the image decoding process comprises:
coding the output image data and generating VLD decoded data in the first image decoding phase by the VLD device;
transmitting the VLD decoded data to the inverse scan device in the first image decoding phase by the VLD device;
scanning the VLD decoded data and generating scanned image data in the first image decoding phase by the inverse scan device;
transmitting the scanned image data to the dequantizer in the first image decoding phase by the inverse scan device;
dequantizing the scanned image data and generating dequantized image data in the first image decoding phase by the dequantizer;
storing the dequantized image data in the memory by the JPEG sub-decoder;
sending the JPEG control signal to the IDCT module by the JPEG sub-decoder;
reading the dequantized image data from the memory by the IDCT module;
transforming the dequantized image data into transformed JPEG data by the IDCT module;
storing the transformed JPEG data in the memory by the IDCT module;
sending the DCT control signal to the JPEG sub-decoder by the IDCT module;
reading the transformed JPEG data from the memory in the second image decoding phase by the JPEG sub-decoder; and
outputting the JPEG data in the second image decoding phase by the output module.

34. The video/image processing method of claim 27, wherein the memory is an 8×8 register array.

35. A video/image encoding method for encoding input video data during an MPEG mode and encoding input image data during a JPEG mode,
during the MPEG mode, the video encoding method, comprising:
encoding the input video data and generating first-MPEG encoded data in a first video encoding phase by an MPEG sub-encoder;
storing the first-MPEG encoded data in a memory by the MPEG sub-encoder;
sending the MPEG control signal to a FDCT (Forward Discrete Cosine Transform) module by the MPEG sub-encoder;
reading the first-MPEG encoded data from the memory by the FDCT module;
transforming the first-MPEG encoded data into transformed MPEG data by the FDCT module;
storing the transformed MPEG data in the memory by the FDCT module;
sending a DCT control signal to the MPEG sub-encoder by the FDCT module;
reading the transformed MPEG data from the memory by the MPEG sub-encoder; and
encoding the input video data in a second video encoding phase by the MPEG sub-encoder; and
during the JPEG mode, the video/image encoding method, comprising:
encoding the input image data and generating first-JPEG-encoded data in a first image encoding phase by an JPEG sub-encoder:
storing the first-JPEG-encoded data in a memory by the JPEG sub-encoder;
sending the JPEG control signal to a FDCT (Forward Discrete Cosine Transform) module by the JPEG sub-encoder;
reading the first-JPEG-encoded data from the memory by the FDCT module;
transforming the first-JPEG-encoded data into transformed JPEG data by the FDCT module;
storing the transformed JPEG data in the memory by the FDCT module;
sending a DCT control signal to the JPEG sub-encoder by the FDCT module;
reading the transformed JPEG data from the memory by the JPEG sub-encoder; and
encoding the input image data in a second image encoding phase by the JPEG sub-encoder.

36. The video/image encoding method of claim 35, wherein the MPEG sub-encoder comprises a receiving module, a motion estimation device, a quantizer, a Zigzag scan device, and a variable-length coding (VLC) device, and during the MPEG mode, the video encoding process comprises:
receiving the input video data in the first video encoding phase by the receiving module;
estimating the input video data and generating estimated video data in the first video encoding phase by the motion estimation device;
storing the estimated video data in the memory by the MPEG sub-encoder;
sending the MPEG control signal to the FDCT module by the MPEG sub-encoder;
reading the estimated video data from the memory by the FDCT module;
transforming the estimated video data into transformed MPEG data by the FDCT module;
storing the transformed MPEG data in the memory by the FDCT module;
sending the DCT control signal to the MPEG sub-encoder by the FDCT module;
reading the transformed MPEG data from the memory in the second video encoding phase by the quantizer;
quantizing the transformed MPEG data and generates the quantized MPEG data in the second video encoding phase by the quantizer;
transmitting the quantized MPEG data to the Zigzag scan device in the second video encoding phase by the quantizer;
scanning the quantized MPEG data and generating the scanned video data in the second video encoding phase by the Zigzag scan device;
transmitting the scanned video data to the VLC device in the second video encoding phase by the Zigzag scan device; and
coding the scanned video data in the second video encoding phase by the VLC device.

37. The video/image encoding method of claim 35, wherein the JPEG sub-encoder comprises a receiving module, a quantizer, a Zigzag scan device, and a variable-length coding (VLC) device, and during the JPEG mode, the image encoding process comprises:
receiving the input image data in the first image encoding phase by the receiving module;
storing the input image data in the memory by the JPEG sub-encoder;
sending the JPEG control signal to the FDCT module by the JPEG sub-encoder;
reading the received input image data from the memory by the FDCT module;
transforming the received input image data into transformed JPEG data by the FDCT module;
storing the transformed JPEG data in the memory by the FDCT module;
sending the DCT control signal to the JPEG sub-encoder by the FDCT module;
reading the transformed JPEG data from the memory in the second image encoding phase by the quantizer;
quantizing the transformed JPEG data and generates the quantized JPEG data in the second image encoding phase by the quantizer;
transmitting the quantized JPEG data to the Zigzag scan device in the second image encoding phase by the quantizer;
scanning the quantized JPEG data and generating the scanned image data in the second image encoding phase by the Zigzag scan device;
transmitting the scanned image data to the VLC device in the second image encoding phase by the Zigzag scan device; and
coding the scanned image data in the second image encoding phase by the VLC device.

38. The video/image encoding method of claim 35, wherein the memory is an 8×8 register array.

39. A video/image decoding method for decoding output video data and output image data, comprising:
a video decoding process, comprising:
decoding the output video data and generating first-MPEG decoded data in a first video decoding phase by an MPEG sub-decoder;
storing the first-MPEG decoded data in a memory by the MPEG sub-decoder;
sending the MPEG control signal to an IDCT (Inverse Discrete Cosine Transform) module by the MPEG sub-decoder;
reading the first-MPEG decoded data from the memory by the IDCT module;
transforming the first-MPEG decoded data into transformed MPEG data by the IDCT module;
storing the transformed MPEG data in the memory by the IDCT module;
sending a DCT control signal to the MPEG sub-decoder by the IDCT module;
reading the transformed MPEG data from the memory by the MPEG sub-decoder; and
decoding the output video data in a second video decoding phase by the MPEG sub-decoder; and
an image decoding process, comprising:
decoding the output image data and generating first-JPEG-decoded data in a first image decoding phase by an JPEG sub-decoder;
storing the first-JPEG-decoded data in a memory by the JPEG sub-decoder;
sending the JPEG control signal to an IDCT (Inverse Discrete Cosine Transform) module by the JPEG sub-decoder;
reading the first-JPEG-decoded data from the memory by the IDCT module;
transforming the first-JPEG-decoded data into transformed JPEG data by the IDCT module;
storing the transformed JPEG data in the memory by the IDCT module;
sending a DCT control signal to the JPEG sub-decoder by the IDCT module;
reading the transformed JPEG data from the memory by the JPEG sub-decoder; and
decoding the output image data in a second image decoding phase by the JPEG sub-decoder.

40. The video/image decoding method of claim 39, wherein the MPEG sub-decoder comprises a variable-length decoding (VLD) device, an inverse scan device, a dequantizer, a motion compensation device, and an output module, and the video decoding process comprises:
coding the output video data and generating VLD decoded data in the first video decoding phase by the VLD device;
transmitting the VLD decoded data to the inverse scan device in the first video decoding phase by the VLD device;
scanning the VLD decoded data and generating scanned video data in the first video decoding phase by the inverse scan device;
transmitting the scanned video data to the dequantizer in the first video decoding phase by the inverse scan device;
dequantizing the scanned video data and generating dequantized video data in the first video decoding phase by the dequantizer;
storing the dequantized video data in the memory by the MPEG sub-decoder;
sending the MPEG control signal to the IDCT module by the MPEG sub-decoder;
reading the dequantized video data from the memory by the IDCT module;
transforming the dequantized video data into transformed MPEG data by the IDCT module;
storing the transformed MPEG data in the memory by the IDCT module;
sending the DCT control signal to the MPEG sub-decoder by the IDCT module;
reading the transformed MPEG data from the memory in the second video decoding phase by the motion compensation device;
compensating the transformed MPEG data and generating the compensated MPEG data in the second video decoding phase by the motion compensation device; and
outputting the compensated MPEG data in the second video decoding phase by the output module.

41. The video/image decoding method of claim 39, wherein the JPEG sub-decoder comprises a variable-length decoding (VLD) device, an inverse scan device, a dequantizer, and an output module, and the image decoding process comprises:
coding the output image data and generating VLD decoded data in the first image decoding phase by the VLD device;
transmitting the VLD decoded data to the inverse scan device in the first image decoding phase by the VLD device;
scanning the VLD decoded data and generating scanned image data in the first image decoding phase by the inverse scan device;
transmitting the scanned image data to the dequantizer in the first image decoding phase by the inverse scan device;
dequantizing the scanned image data and generating dequantized image data in the first image decoding phase by the dequantizer;
storing the dequantized image data in the memory by the JPEG sub-decoder;
sending the JPEG control signal to the IDCT module by the JPEG sub-decoder;
reading the dequantized image data from the memory by the IDCT module;
transforming the dequantized image data into transformed JPEG data by the IDCT module;
storing the transformed JPEG data in the memory by the IDCT module;
sending the DCT control signal to the JPEG sub-decoder by the IDCT module;
reading the transformed JPEG data from the memory in the second image decoding phase by the JPEG sub-decoder; and
outputting the JPEG data in the second image decoding phase by the output module.

42. The video/image processing method of claim 39, wherein the memory is an 8×8 register array.

43. A video/image processing device, comprising:
a memory for storing first processed data, second processed data, discrete cosine transformed data, and inverse discrete cosine transformed data;
an MPEG subsystem for processing an MPEG codec according to first input data and the discrete cosine transformed data, generating the first processed data and a first trigger signal, and storing the first processed data to the memory in response to receiving a first enable signal;
a JPEG subsystem for processing JPEG codec according to second input data and the discrete cosine transformed data, generating the second processed data and a second trigger signal, and storing the second processed data to the memory in response to receiving a second enable signal; and
a discrete cosine transform module coupled to the MPEG subsystem and the JPEG subsystem for transforming the first processed, data according to the first trigger signal, into one of the discrete cosine transformed data and the inverse discrete cosine transformed data, transforming the second processed data, according to the second trigger signal, into one of the discrete cosine transformed data and the inverse discrete cosine transformed data, and storing an output of the discrete cosine transform module to the memory.

44. The image processing device as claimed in claim 43, further comprising a processor for providing the first enable signal and the second enable signal.

45. The image processing device as claimed in claim 43, wherein the MPEG subsystem comprises:
a motion estimation device generating estimation information of the first input data and coupled to the discrete cosine transform module;
a quantizer coupled to the motion estimation device;
a scan device coupled to the quantizer;
a variable-length coding device coupled to the scan device;
a transmit buffer coupled to the variable-length coding device for storing a compressed data;
a receive buffer for providing the compressed data;
a variable-length decoding device coupled to the receive buffer;
an inverse scan device coupled to the variable-length decoding device;
a dequantizer coupled to the inverse scan device; and
a motion compensation processor coupled to the dequantizer for generating a display image.

46. The image processing device as claimed in claim 43, wherein the JPEG subsystem comprises:
a quantizer coupled to the memory;
a scan device coupled to the quantizer;
a variable-length coding device coupled to the scan device;
a transmit buffer coupled to the variable-length coding device for storing a compressed data;
a receive buffer for providing the compressed data;
a variable-length decoding device coupled to the receive buffer;
an inverse scan device coupled to the variable-length decoding device; and
a dequantizer coupled to the inverse scan device.

47. The image processing device as claimed in claim 43, wherein the MPEG subsystem comprises:
a motion estimation device generating the first processed data, the first trigger signal for triggering the discrete cosine transform module, and estimation information of the first input data, and storing the first processed data to the memory;
a quantizer for quantizing the discrete cosine transformed data, generating a quantized data, and storing the quantized data to the memory;
a scan device for scanning the quantized data in the memory, transforming the quantized data into serial string data;
a variable-length coding device for variable-length coding the serial string data to generate compressed data; and
a transmit buffer coupled to the variable-length coding device for storing the compressed data.

48. The image processing device as claimed in claim 43, wherein the MPEG subsystem comprises:
a receive buffer for providing compressed data;
a variable-length decoding device for variable-length decoding the compressed data to generate serial string data;
an inverse scan device for transforming the serial string data into quantized data, and storing the quantized data to the memory;
a dequantizer for accessing the quantized data, dequantizing the quantized data to the first processed data, storing the first processed data to the memory, and generating the first trigger signal for triggering the discrete cosine transform module; and
a motion compensation processor for accessing the inverse discrete cosine transformed data and generating a display image.

49. The image processing device as claimed in claim 43, wherein the MPEG subsystem comprises:
means for providing compressed data;
means for variable-length decoding the compressed data to generate serial string data;
means for transforming the serial string data into quantized data, and storing the quantized data to the memory;
means for accessing the quantized data, dequantizing the quantized data to the first processed data, storing the first processed data to the memory, and generating the first trigger signal for triggering the discrete cosine transform module; and
means for accessing the inverse discrete cosine transformed data and generating a display image.

50. The image processing device as claimed in claim 43, wherein the JPEG subsystem comprises:
a quantizer for quantizing the discrete cosine transformed data, generating quantized data, and storing the quantized data to the memory;
a scan device for scanning the quantized data in the memory, transforming the quantized data into serial string data;
a variable-length coding device for variable-length coding the serial string data to generate compressed data; and
a transmit buffer coupled to the variable-length coding device for storing the compressed data.

51. The image processing device as claimed in claim 43, wherein the JPEG subsystem comprises:
means for quantizing the discrete cosine transformed data, generating quantized data, and storing the quantized data to the memory;
means for scanning the quantized data in the memory, transforming the quantized data into serial string data;
means for variable-length coding the serial string data to generate compressed data; and
means for storing the compressed data.

52. The image processing device as claimed in claim 43, wherein the JPEG subsystem comprises:
a receive buffer for providing compressed data;
a variable-length decoding device for variable-length decoding the compressed data to generate serial string data;
an inverse scan device for transforming the serial string data into quantized data, and storing the quantized data to the memory; and
a dequantizer for accessing the quantized data, dequantizing the quantized data to the second processed data, storing the second processed data to the memory, and generating the second trigger signal for triggering the discrete cosine transform module to generate a display image.

53. The image processing device as claimed in claim 43, wherein the JPEG subsystem comprises:
means for providing compressed data;
means for variable-length decoding the compressed data to generate serial string data;
means for transforming the serial string data into quantized data, and storing the quantized data to the memory; and
means for accessing the quantized data, dequantizing the quantized data to the second processed data, storing the second processed data to the memory, and generating the second trigger signal for triggering the discrete cosine transform module to generate a display image.

54. The image processing device as claimed in claim 43, wherein the memory is a register array.

55. The image processing device as claimed in claim 43, wherein the scan device scans the quantized data in the memory according to a zigzag scan pattern.
